(19) United States
(12) Patent Application Publication
(10) Pub. No.: US 2024/0429629 A1
(43) Pub. Date: Dec. 26, 2024

(54) SYSTEM AND METHOD FOR ELECTRICAL CONNECTION

(71) Applicant: 2798386 Ontario Inc., London (CA)

(72) Inventor: Mandeep SINGH, London (CA)

(73) Assignee: 2798386 Ontario Inc., London, ON (CA)

(21) Appl. No.: 18/749,971

(22) Filed: Jun. 21, 2024

Related U.S. Application Data
(60) Provisional application No. 63/509,804, filed on Jun. 23, 2023.
(60) Provisional application No. 63/601,820, filed on Nov. 22, 2023.
(60) Provisional application No. 63/614,969, filed on Dec. 27, 2023.

(51) Int. Cl. H01R 4/245; H02G 15/10

(52) U.S. Cl. CPC H01R 4/245; H02G 15/10

(57) ABSTRACT

A system for electrically connecting first and second load wires and first and second source wires. The system includes a lock body defining a receptacle inside the lock body. The system also includes first and second contact elements for electrically connecting the load wires and the source wires. The load wires are connectable to the first and second contact elements at first and second load ends thereof. The system includes one or more slider bodies slidably received in the receptacle, and the contact elements are partially mounted in the slider bodies. The system includes one or more pinch levers mounted to the lock body and movable from an inactive position to a locked position. When the pinch lever is moved to its locked position, the slider body is moved in the receptacle relative to the lock body, and the contact elements engage the source wires for electrical connection therewith.

### CROSS-REFERENCE TO RELATED APPLICATION

This application claims the benefit of U.S. Provisional patent Applications Nos. 63/509,804, filed on Jun. 23, 2023, 63/601,820, filed on Nov. 22, 2023, and 63/614,969, filed on Dec. 27, 2023, the entirety of all of which provisional patent applications is hereby incorporated herein by reference thereto.

### FIELD OF THE INVENTION

The present invention is a system and method for electrical connection of conductors.

### BACKGROUND OF THE INVENTION

As is well known in the art, landscape lighting systems typically include a number of lights that are electrically connected via conductors to a source of electrical energy. For ease of installation, the lights may be connected at a junction box via electrically conductive conductors (i.e., lead wires) to other electrically conductive conductors (i.e., main cable wires in a main cable) connected to the electrical energy source.

The conventional junction box is made to be located in the open, e.g., in a flower bed or along a path, at a relatively short distance from the light or lights associated with the junction box. Typically, the junction box includes a housing inside which a main cable is electrically connected with lead wires from the light(s). Because it is intended to be located outside, the junction box is intended to be generally impervious to water.

The conventional junction boxes tend to be somewhat complex, and connecting wires inside the conventional junction boxes typically takes some time. For example, to connect the wires, insulation covering the wires may be manually removed to an extent sufficient for exposure of the bare wires that are then manually spliced (i.e., wrapped) or otherwise connected. At this point, material intended to electrically isolate the wires at the splice (e.g., black adhesive tape) may be wrapped around the spliced wires. The spliced wires are then positioned inside the junction box. Subsequently, additional material is typically placed on or over an exterior of the prior art junction box, in an attempt at weatherproofing.

Because the prior art junction boxes generally involve manually connecting wires, and manually insulating the connection, there is a substantial risk of the junction box failing to prevent water from entering into the junction box. Also, the mechanical strength of the connection tends to vary, depending on the installer's skill and experience. After installation, cables or wires may be pulled for various reasons (e.g., yard work), and this may cause an open circuit or a short circuit.

Another type of problem in connecting conductors in a prior art landscape lighting system arises where a main cable, e.g., connected to a source of electrical energy, is too short to reach the prior art junction box. To address this, typically, another segment of another main cable, connected to a load (e.g., lights) may be spliced to the first main cable, in the field. In the prior art, however, because the spliced main cable segments are intended to be weatherproof, splicing them together in the field tends to be a time-consuming process, because an electrical insulation covering (e.g., black adhesive tape) may be manually wrapped around the spliced segments. Also, there is a risk that the insulation covering that is manually secured at the site around the spliced segments of the main cables may not be waterproof.

### SUMMARY OF THE INVENTION

For the foregoing reasons, there is a need for a system and method for electrical connection of conductors that overcomes or mitigates one or more of the disadvantages and defects of the prior art.

In its broad aspect, the invention provides a system for electrically connecting first and second load wires and first and second source wires. The system includes a lock body defining a receptacle inside the lock body. The system also includes first and second contact elements for electrically connecting the load wires and the source wires. The load wires are connectable to the first and second contact elements at first and second load ends thereof. The system includes one or more slider bodies slidably received in the receptacle, and the contact elements are partially mounted in the slider bodies. The system includes one or more pinch levers mounted to the lock body and movable from an inactive position to a locked position. When the pinch lever is moved to its locked position, the slider body is moved in the receptacle relative to the lock body, and the contact elements engage the source wires for electrical connection therewith.

### BRIEF DESCRIPTION OF THE DRAWINGS

The invention will be better understood with reference to the attached drawings, in which:

FIG. 1A is an exploded view of an embodiment of the system of the invention;

FIG. 1B is an isometric view of the system of FIG. 1A with a pinch lever thereof in a locked position, in which load wires are shown connected with the system, drawn at a larger scale;

FIG. 1C is a side view of an embodiment of a slider body included in the system with the load wires connected to contact elements inside the slider body, and with a pinch lever positioned in an inactive position thereof, drawn at a larger scale;

FIG. 1D is an isometric view of the slider body and the pinch lever of FIG. 1C;

FIG. 1E is an isometric view of the pinch lever of FIGS. 1C and 1D, drawn at a larger scale;

FIG. 1F is a side view of the slider body and the pinch lever of FIGS. 1C and 1D in which the pinch lever is in the locked position thereof, drawn at a smaller scale;

FIG. 2A is a top view of the system of FIG. 1A in which the pinch lever is in the inactive position thereof, drawn at a smaller scale;

FIG. 2B is a cross-section of the system of FIG. 2A, taken along line A-A in FIG. 2A;

FIG. 3A is a top view of the system of FIG. 2A in which the pinch lever is in the locked position thereof;

FIG. 3B is a cross-section taken along line B-B in FIG. 3A showing first and second source ends of the first and second contact elements extending from an external side of a floor element of a lock body of the system at least partially into a main cable;

FIG. 4 is an isometric view of an embodiment of a slider body of the system of FIGS. 1A-3B with the load wires inserted therein and connected therein to the contact elements showing the first and second source ends of the first and second contact elements extending from the slider body, drawn at a larger scale;

FIG. 5 is an isometric view of the slider body of FIG. 4 positioned in the lock body of the system of FIGS. 1A-4, drawn at a smaller scale;

FIG. 6 is an isometric view of the lock body of FIG. 5 from which the slider body is omitted, showing first and second load ends of the first and second contact elements connected with respective first and second end segments of the first and second load wires;

FIG. 7 is an isometric view of the lock body of FIG. 5 showing a first side of the lock body, and in which the slider body is located in the lock body and a slider case is positioned inside the lock body;

FIG. 8 is an isometric view of the system of FIG. 1A in which the load wires are connected to the first and second load ends of the first and second contact elements inside the system and the pinch lever is in the inactive position thereof;

FIG. 9 is an isometric view of the system of FIG. 1A in which the pinch lever is in the locked position thereof;

FIG. 10A is an isometric view of the system in which a door mounted to a second side of the lock body is in an open position thereof and the pinch lever is in the inactive position thereof, drawn at a smaller scale;

FIG. 10B is an isometric view of the system of FIG. 10A in which a locked segment of a main cable including first and second source wires is positioned adjacent to the external side of the floor element of the lock body;

FIG. 10C is an isometric view of the system of FIG. 10B in which the door is closed, to hold the locked segment of the main cable adjacent to the external side of the floor element of the lock body;

FIG. 10D is an isometric view of the system of FIG. 10C in which the pinch lever has been moved to the locked position thereof, for connecting the first and second load wires with first and second source wires in the main cable respectively;

FIG. 10E is an isometric view of the system of FIG. 10C from which the main cable is omitted, and in which the pinch lever is in the inactive position, showing the external side of the floor element of the body, drawn at a larger scale;

FIG. 10F is an isometric view of the system of FIG. 10E in which the pinch lever is in the locked position thereof, and the first and second source ends of the contact elements are shown extending from the external side of the floor element;

FIG. 10G is an isometric view of an embodiment of the system of the invention including an indicator subassembly, drawn at a smaller scale;

FIG. 10H is a schematic circuit diagram relating to an embodiment of the indicator subassembly of FIG. 10G;

FIG. 11A is an isometric view of another embodiment of the system of the invention in which pinch levers thereof are in inactive positions, drawn at a larger scale;

FIG. 11B is an isometric view of the system of FIG. 11A in locked positions, with segments of first and second main cables secured therein;

FIG. 11C is an isometric view of the system of FIG. 11A with the pinch levers in the inactive positions and a clamp device thereof in an open position, showing respective first and second troughs in which segments of the first and second main cables are receivable;

FIG. 11D is another isometric view of the system of FIG. 11C with the clamp device omitted therefrom;

FIG. 11E is an end view of the junction box of FIG. 11A with the pinch levers in the inactive positions and in which the clamp device is in a closed position, partially defining two compartments in which the first and second main cables are receivable;

FIG. 12A is a top view of the system of FIG. 11A;

FIG. 12B is a longitudinal section of the system of FIG. 11A taken along line 2A-2A′ in FIG. 12A;

FIG. 12C is a cross-section of the system of FIG. 11A, taken along line 2B-2B′ in FIG. 12A;

FIG. 12D is an isometric view of an embodiment of a slider subassembly of the invention included in the system of FIG. 11A, drawn at a larger scale;

FIG. 13A is an isometric view of the system of FIG. 11B in which the pinch levers are in the locked positions, and from which the main cables are omitted, drawn at a smaller scale;

FIG. 13B is a top view of the system of FIG. 13A;

FIG. 13C is a longitudinal section of the system of FIG. 13B taken along line 3A-3A′ in FIG. 13B;

FIG. 13D is a cross-section of the system of FIG. 13B taken along line 3B-3B′ in FIG. 13B;

FIG. 13E is another isometric view of the system in which the pinch levers are in the locked positions, with the clamp device omitted;

FIG. 14A is an isometric view of the system of FIG. 11A from which certain elements are omitted, showing the slider subassemblies positioned in a slider case in a lock body;

FIG. 14B is an isometric view of the system of FIGS. 11A and 14A showing contact elements with portions thereof positioned in respective floor element slots in the floor element of the lock body;

FIG. 14C is a top view of the floor element, showing the floor element slots in the floor element;

FIG. 15A is a top view of the system of FIGS. 13A and 13B with the first and second main cables secured therein, drawn at a smaller scale;

FIG. 15B is a top view of the system of FIG. 15A with certain elements omitted, showing the contact elements in relation to the main cables;

FIG. 15C is a longitudinal section of the system of FIG. 15A taken along line 4A-4A′ in FIG. 15A showing the contact elements in contact with main cable wires;

FIG. 15D a cross-section of the system of FIG. 15A taken along line 4B-4B′ in FIG. 15A, showing the contact elements in contact with certain main cable wires; and

FIG. 15E is an isometric view of the system of FIG. 15A with segments of the first and second main cables positioned in the respective first and second troughs.

### DETAILED DESCRIPTION

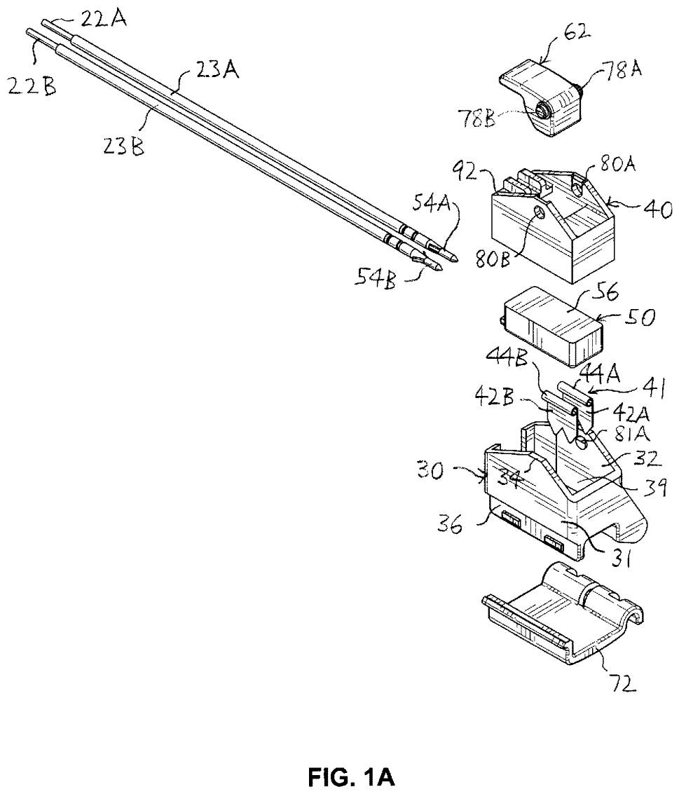

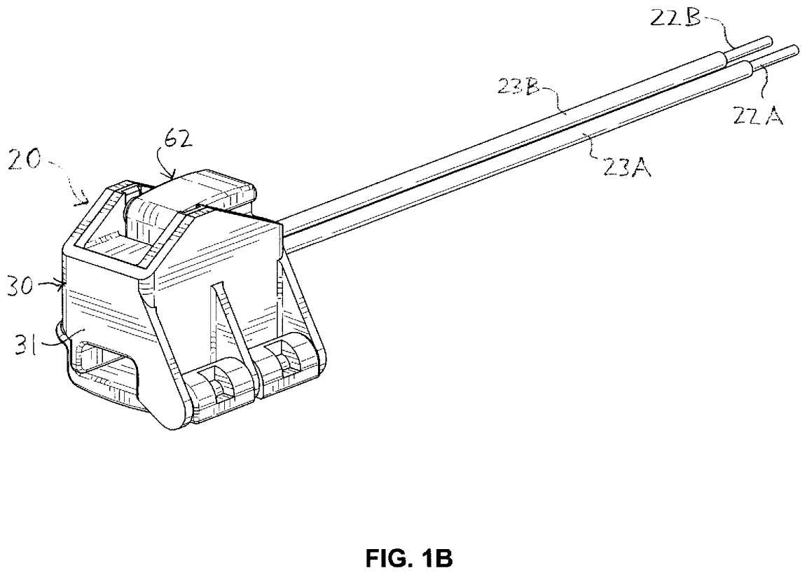

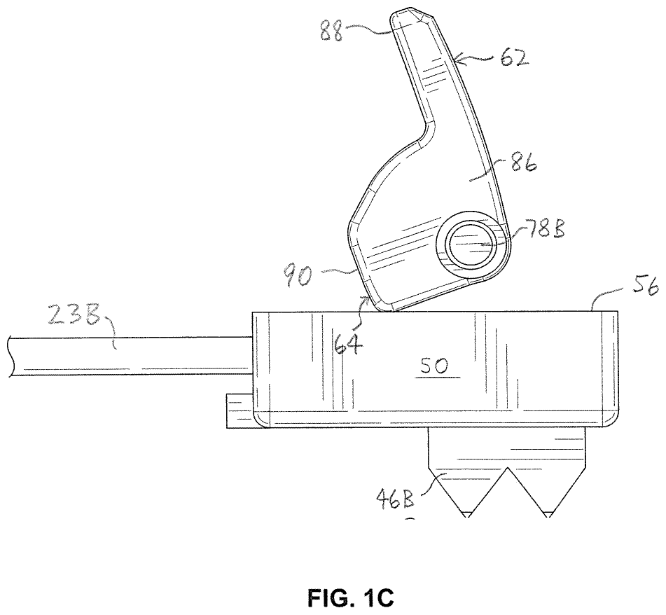

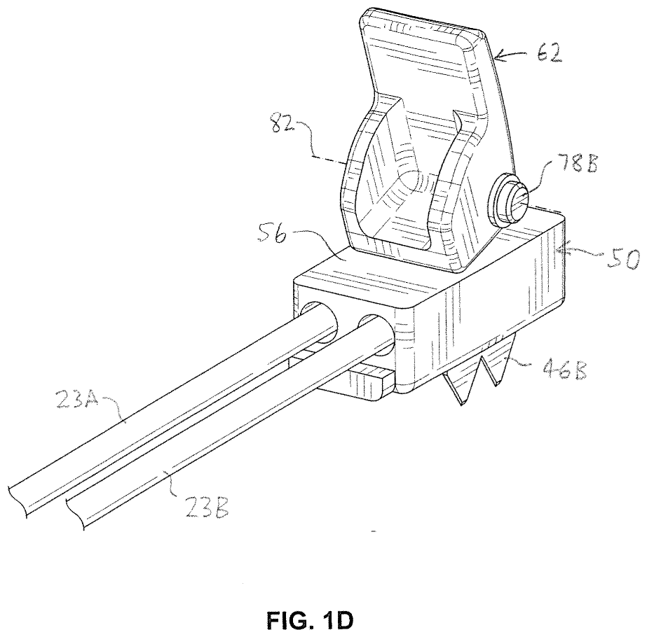

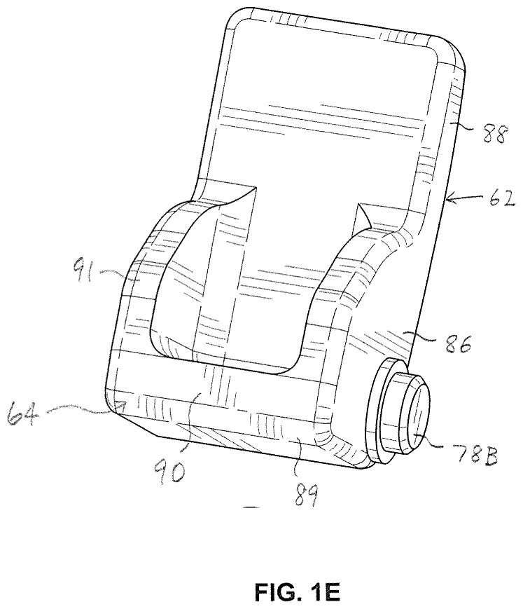

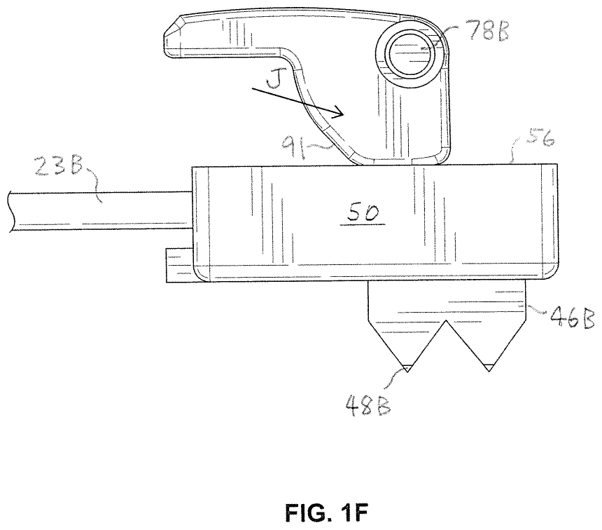

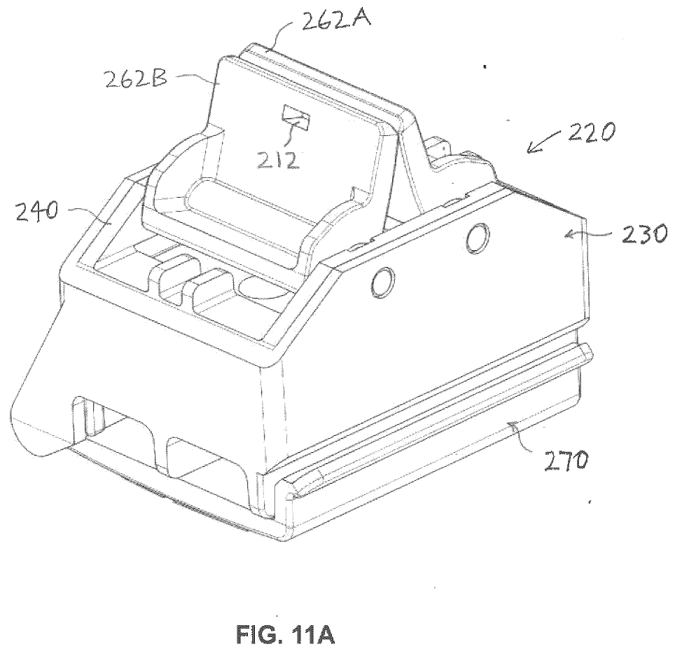

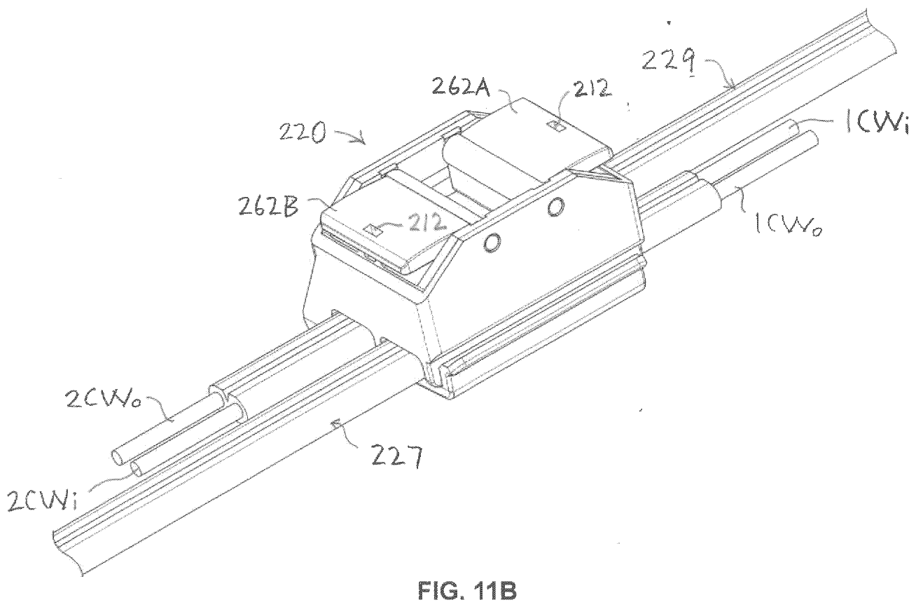

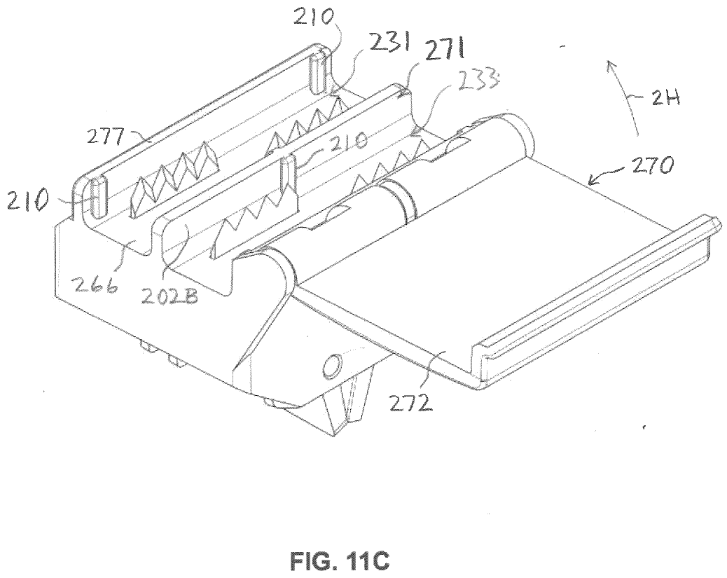

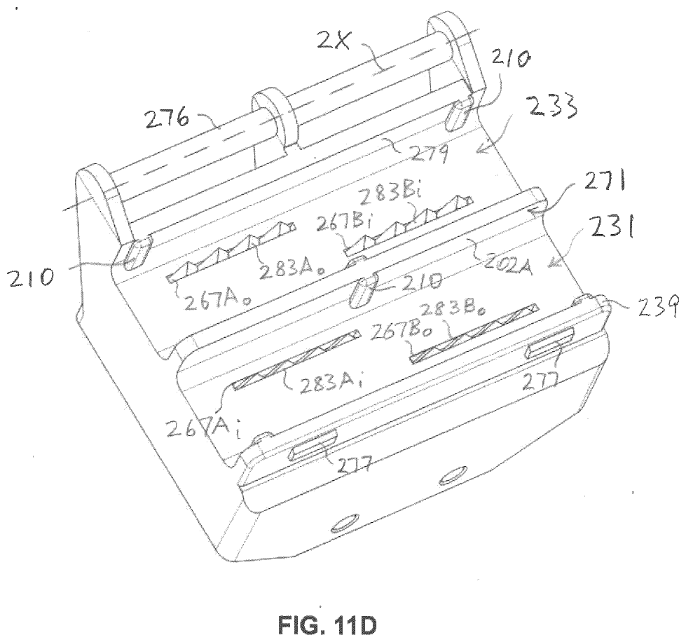

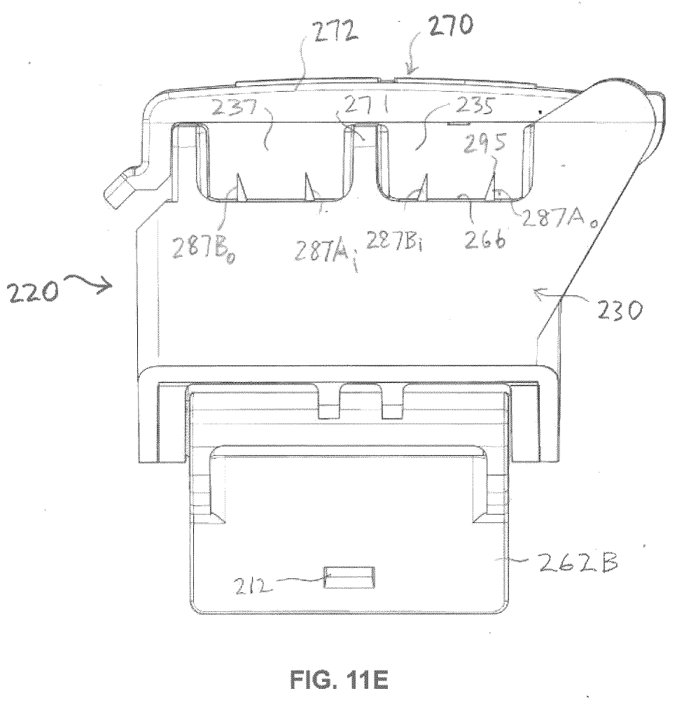

In the attached drawings, like reference numerals designate corresponding elements throughout. In particular, the reference numerals used in FIGS. 1A-10H are used in connection with the embodiment of the invention illustrated in FIGS. 11A-15E, except that each such reference numeral is raised by 200, where the elements correspond to elements illustrated in FIGS. 1A-10H. Reference is first made to FIGS. 1A-10F to describe an embodiment of a system in accordance with the invention indicated generally by the numeral 20.

As will be described, the system 20 is for electrically connecting conductors, namely, first and second load wires 22A, 22B and first and second source wires 28A, 28B respectively. The system 20 is for electrically connecting the first load wire 22A with the first source wire 28A, and for electrically connecting the second load wire 22B with the second source wire 28B. It will be understood that, in connection with the embodiments illustrated in FIGS. 1A-10G, the load wires 22A, 22B are lead wires that connect the system 20 with one or more lights (not shown), and the source wires 28A, 28B are main cable wires, for connecting the system 20 with a source of electrical energy (not shown).

In one embodiment, the system 20 preferably includes a lock body 30 with one or more walls 31 thereof extending between a first side 34 and a second side 36 thereof. Preferably, the lock body 30 includes a floor element 38 secured to the wall 31 and located between the first and second sides 34, 36. As will be described, the lock body 30 preferably defines a receptacle 39 therein between the first side 34 and the floor element 38.

In one embodiment, the system 20 preferably also includes one or more contact element pairs 41. The pair 41 preferably includes a first contact element 42A and a second contact element 42B, for electrically connecting, via the first contact element 42A, the first load wire 22A and the first source wire 28A, and for electrically connecting, via the second contact element 42B, the second load wire 22B and the second source wire 28B.

As can be seen in FIG. 1A, the first contact element 42A preferably extends between a first load end 44A thereof, at which the first contact element 42A is formed for electrical connection with the first load wire 22A, and a first source end 46A thereof, at which the first contact element 42A is formed for electrical connection with the first source wire 28A. It is also preferred that the second contact element 42B extends between a second load end 44B thereof, at which the second contact element 42B is formed for electrical connection with the second load wire 22B, and a second source end 46B thereof, at which the second contact element 42B is formed for electrical connection with the second source wire 28B.

It is also preferred that the system 20 includes one or more slider bodies 50. In the embodiment illustrated in FIGS. 1A-10F, the system 20 includes one slider body 50. The slider body 50 is receivable in the receptacle 39. Preferably, the slider body 50 is configured for movement in the receptacle 39 relative to the lock body 30. In one embodiment, the contact element pair 41 preferably is at least at least partially mounted in the slider body 50, for movement of the contact element pair 41 with the slider body 50 relative to the look body 30.

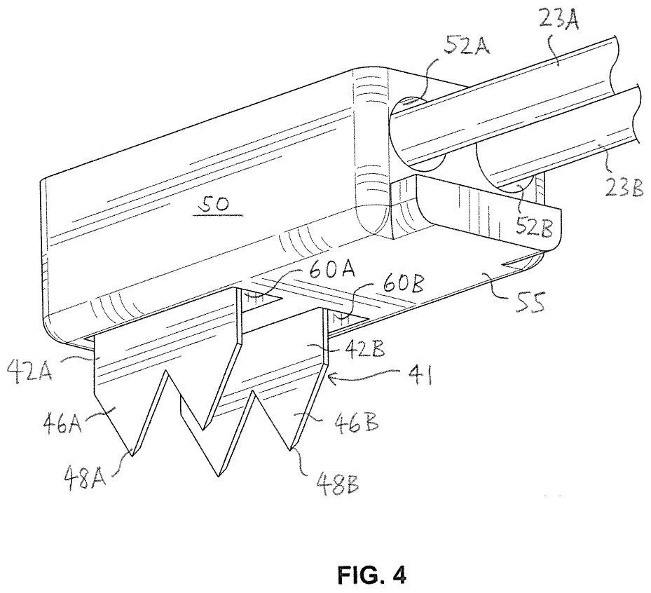

In one embodiment, the slider body 50 preferably includes first side 56 (FIG. 1D) and an opposed second side 55 (FIG. 4). As can be seen, e.g., in FIG. 4, the first and second source ends 46A, 46B of the respective first and second contact elements 42A, 42B preferably project beyond the second side 55 of the slider body 50.

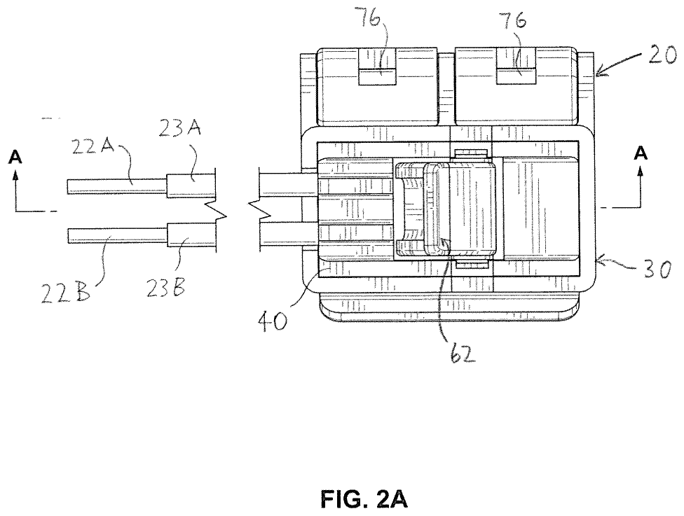

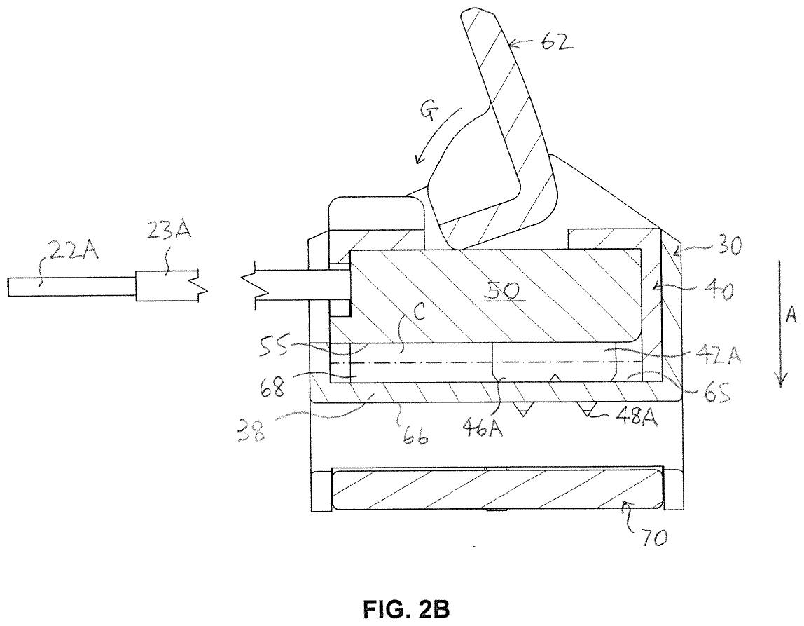

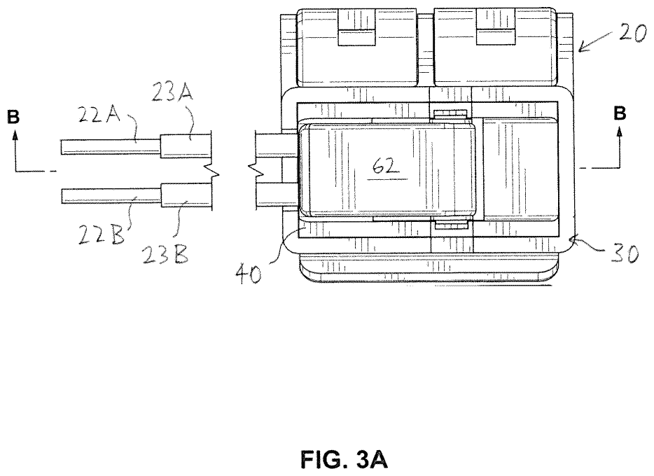

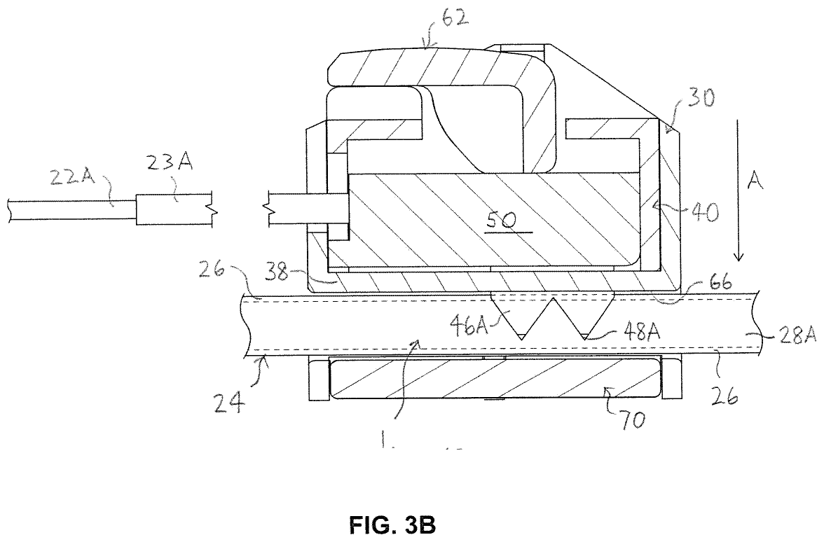

The system 20 preferably also includes one or more pinch levers 62 movably mounted to the lock body 30. In the embodiment illustrated in FIGS. 1A-10F, the system 20 includes one pinch lever 62. The pinch lever 62 preferably is movable to a locked position thereof (e.g., as shown in FIGS. 1B, 1F, 3A, 3B), in which the pinch lever 62 locates the slider body 50 proximate to the floor element 38, from an inactive position of the pinch lever 62 (e.g., as shown in FIGS. 1C, 1D, 2A, and 2B), in which the slider body 50 is located distal to the floor element 38.

As can be seen in FIG. 2B, the slider body 50 preferably is located spaced apart from the floor element 38 to define a cavity “C” therebetween, when the pinch lever 62 is in the inactive position thereof. Upon the pinch lever 62 moving from the inactive position to the locked position thereof, the slider body 50 is urged by the pinch lever 62 toward the floor element 38, and the first contact element 42A and the second contact element 42B engage the first and second source wires 28A, 28B respectively, to electrically connect the first load wire 22A with the first source wire 28A, and to electrically connect the second load wire 22B with the second source wire 28B.

As will be described, in one embodiment, when the pinch lever 62 is in its locked position, the slider body 50 preferably is engaged with the floor element 38 (FIG. 3B). Preferably, the pinch lever 62 and the slider body 50 cooperate to form an over center lock when the pinch lever 62 is in the locked position thereof, securing the slider body 50 against the floor element (FIG. 3B).

In one embodiment, the system 20 preferably includes a slider case 40 positioned in the receptacle 39 of the lock body 30. The slider body 50 preferably is receivable in the slider case 40, and is movable relative to the slider case 40.

It is also preferred that the system 20 includes a gel 68 that is positioned in the cavity “C”, when the pinch lever 62 is in the inactive position thereof, as illustrated in FIG. 2B. It will be understood that the gel 68 preferably is at least partially squeezed out of the cavity by the slider body 50, when the pinch lever 62 is moved to the locked position thereof, as will be described.

In one embodiment, the system 20 preferably also includes a clamp device 70 mounted to the second side 36 of the lock body 30, for holding the first and second source wires stationary in relation to the lock body while said at least one pinch lever is moved from the inactive position to the locked position thereof.

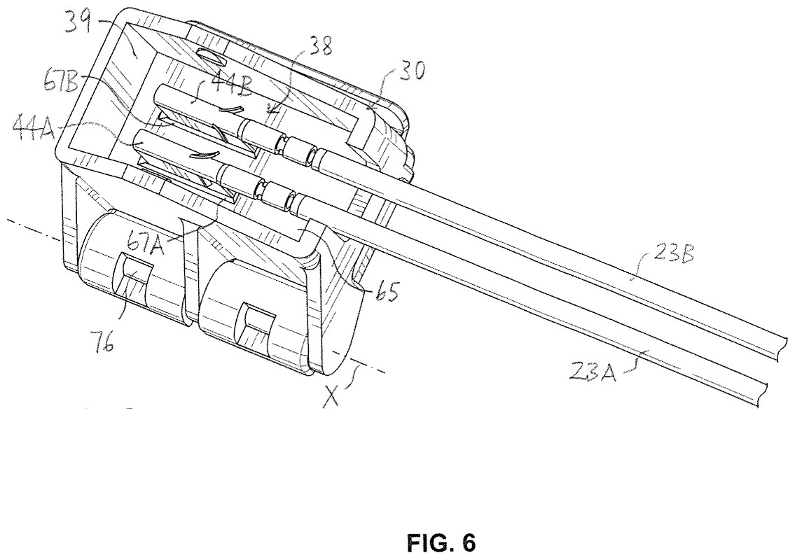

In use, an embodiment of a method of the invention preferably includes electrically connecting the first load wire 22A with the first load end 44A of the first contact element 42A, and electrically connecting the second load wire 22B with the second load end 44B of the second contact element 42B. As can be seen, e.g., in FIGS. 1A and 6, the first and second load ends 44A, 44B may be crimped onto the first and second wires 22A, 22B respectively.

Next, the first contact element 42A and the second contact element 42B preferably are at least partially mounted to the slider body 50. As a result, the first and second load wires 22A, 22B remain attached to the first and second load ends 44A, 44B of the first and second contact elements 42A, 42B while the first and second load ends 44A, 44B are positioned inside the slider body 50, as illustrated in FIGS. 1C, 1D, 1F, and 6-8.

The lock body 30 is provided, and the slider body 50 (with the first and second load ends 44A, 44B of the first and second contact elements 42A, 42B crimped to ends of the first and second load wires 22A, 22B and located inside the slider body 50) is positioned in the receptacle 39. It will be understood that the slider body 50 is movable in the receptacle 39 relative to the lock body 30. Because the first and second contact elements 42A, 42B are at least partially mounted to the slider body 50, movement of the slider body 50 causes corresponding movement of the first and second contact elements 42A, 42B.

In one embodiment, one or more pinch levers 62 are provided, the pinch lever 62 preferably being movably mounted to the lock body 30 for movement of the pinch lever 62 from an inactive position to a locked position thereof.

The pinch lever 62 preferably is moved from the inactive position thereof toward the locked position thereof, to urge the slider body 50 toward the floor element 38. Due to such movement of the slider body 50 relative to the lock body 30, the first and second source ends 46A, 46B of the first and second contact elements 42A, 42B are engaged with the first and second source wires 28A, 28B. Due to such engagement, the first source end 46A of the first contact element 42A is electrically connected with the first source wire 28A, and the second source end 46B of the second contact element 42B is electrically connected with the second source wire 28B. As a result, the first load wire 22A and the first source wire 28A are electrically connected via the first contact element 42A, and the second load wire 22B and the second source wire 28B are electrically connected via the second contact element 42B.

In one embodiment, illustrated in FIG. 1A-10F, the system 20 or junction box is for electrically connecting electrical conductors that are respective lead wires (i.e., the load wires 22A, 22B) with respective main cable wires (FIGS. 3B,10D) (i.e., the source wires 28A, 28B). The main cable wires are connected with a source of electrical energy (not shown), and the lead wires are connected with a load, e.g., one or more lights.

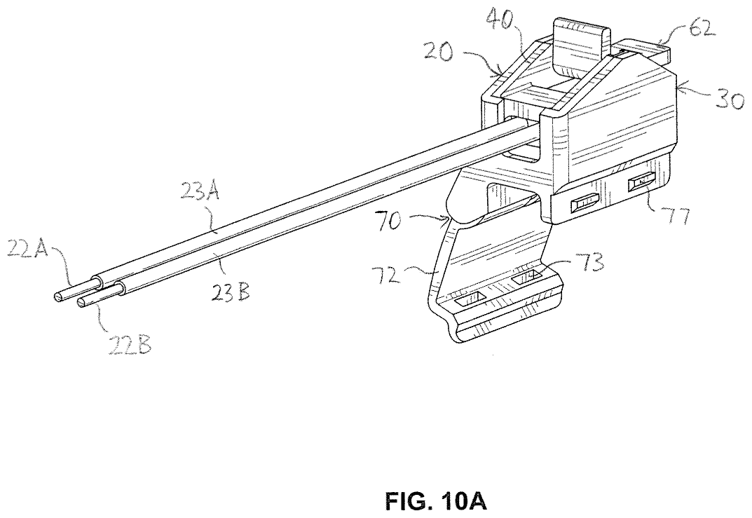

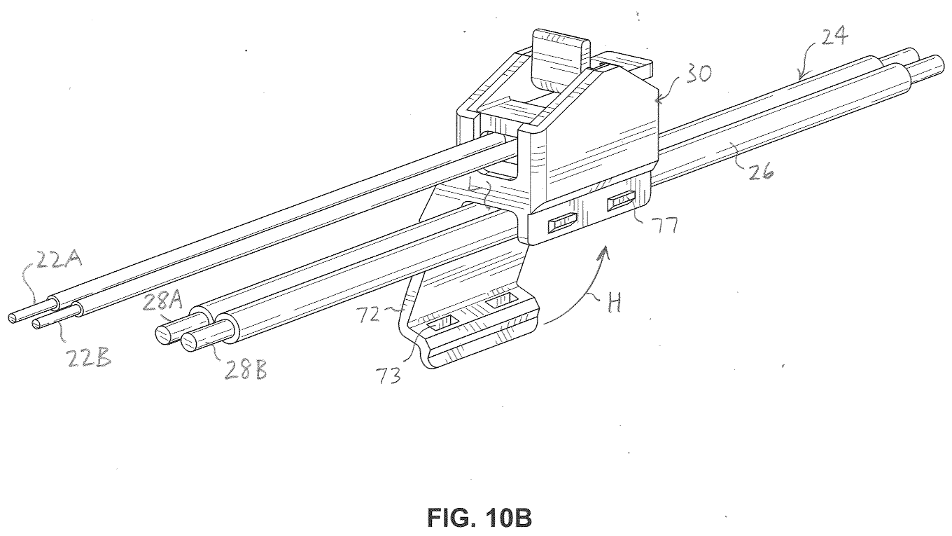

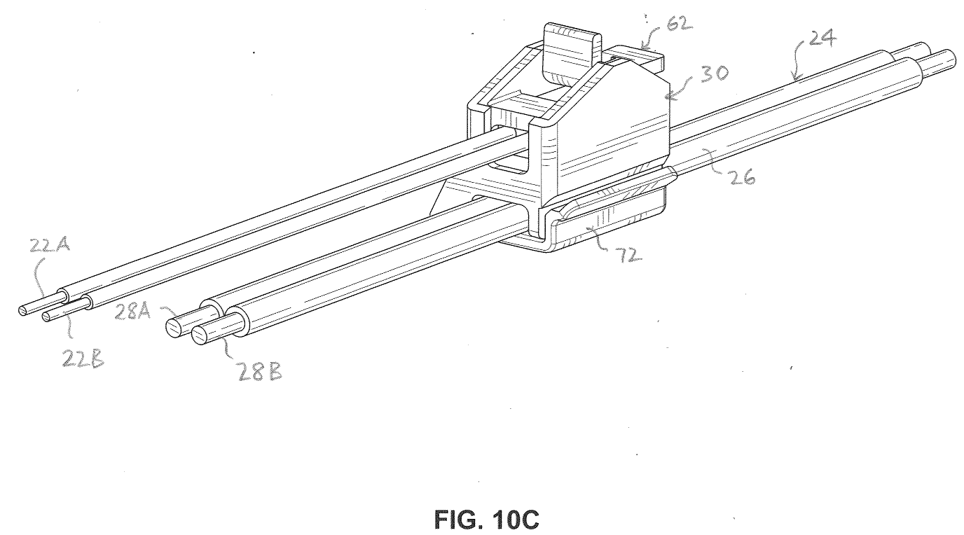

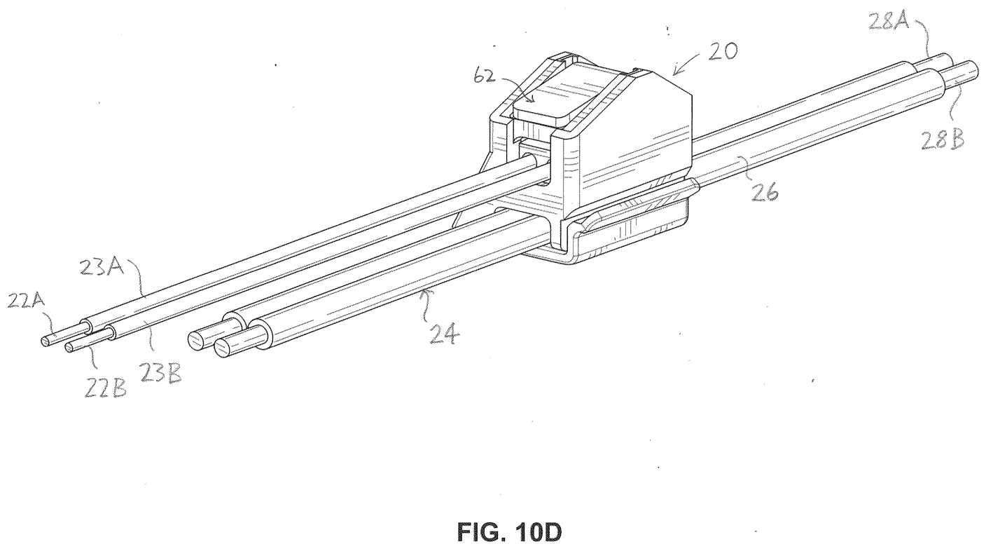

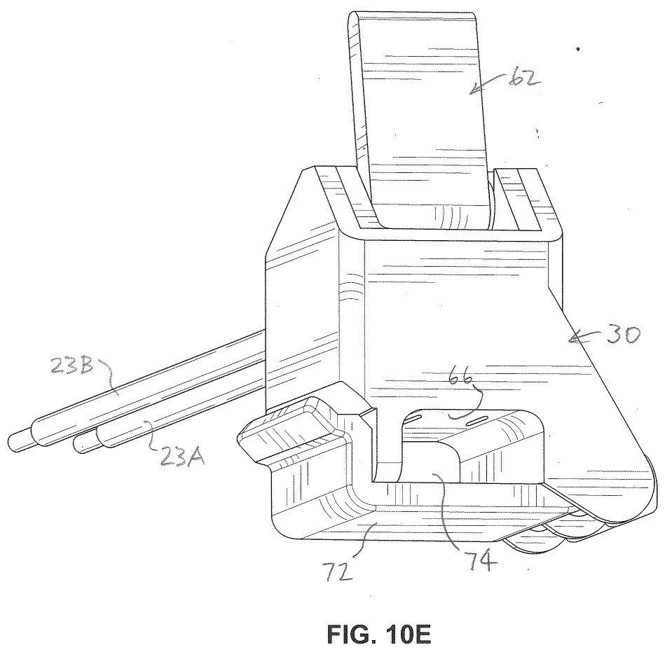

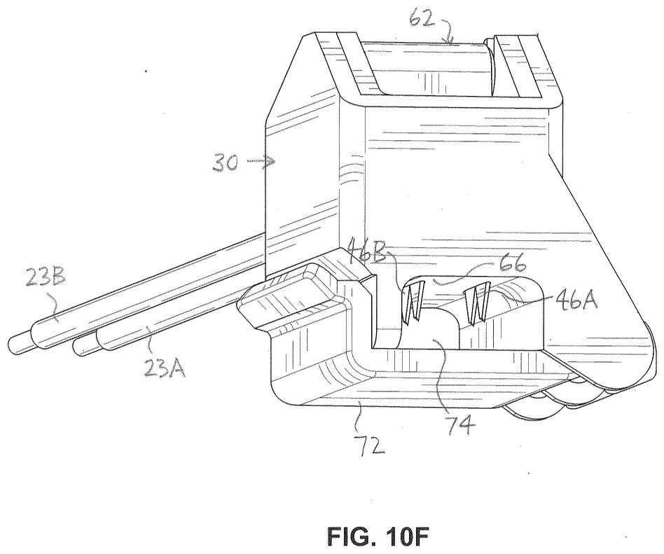

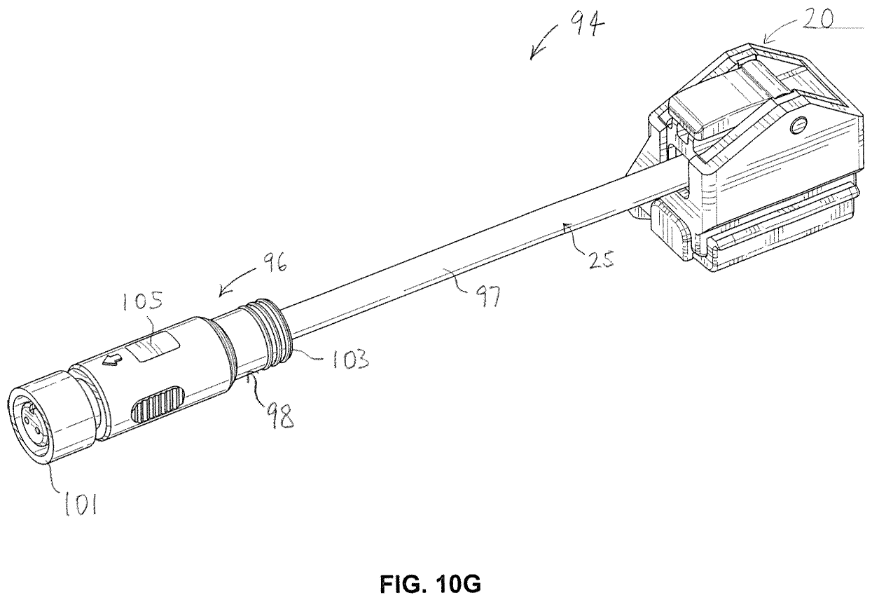

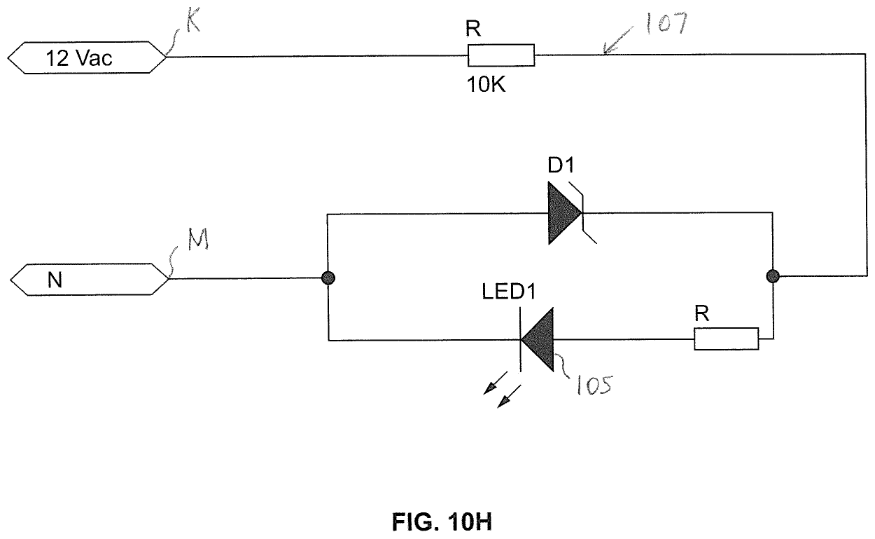

The main cable wires 28A, 28B are included in a main cable 24, and the main cable wires 28A, 28B are generally protected by insulation 26 (FIG. 10B). The lead wires 22A, 22B are generally protected by insulation 23A, 23B (FIG. 1A). In one embodiment, the junction box 20 preferably includes the lock body 30 that extends between a lead side (i.e., the first side 34) and a main cable side (i.e., the second side 36) thereof. The lock body 30 defines an opening 32 therein, at the lead side 34. As noted above, the lock body 30 preferably includes the floor element 38 located between the lead side 34 and the main cable side 36 (FIGS. 2B, 3B, 6).

As noted above, the first and second contact elements 42A, 42B preferably include first and second source ends 46A, 46B that engage the first and second main cable wires 28A, 28B respectively. The engagement results in electrical connection of the first and second lead wires 22A, 22B with the first and second main wires 28A, 28B respectively. Those skilled in the art would appreciate that the electrical connection may be achieved in different ways.

In one embodiment, and as can be seen in FIGS. 1A and 4, it is also preferred that the first and second contact elements 42A, 42B are blade contacts for connecting the lead wires 22A, 22B with the main cable wires 28A, 28B respectively. The first and second blade contacts 42A, 42B preferably extend between the first ends (i.e., the first and second load ends 44A, 44B thereof), at which each of the contact elements 42A, 42B is electrically connected with a respective one of the first and second lead wires 22A, 22B (FIG. 6), and second ends (i.e., the first and second source ends 46A, 46B thereof).

In one embodiment, the second ends 46A, 46B of the first and second contact elements 42A, 42B preferably include sharpened points 48A, 48B for puncturing through the insulation 26 to engage the respective main cable wires 28A, 28B (FIGS. 3B, 4).

As can be seen in FIG. 4, in one embodiment, each of the first and second contact elements 42A, 42B preferably includes two sharpened points. It will be understood that the first and second contact elements 42A, 42B may each include one or more sharpened points.

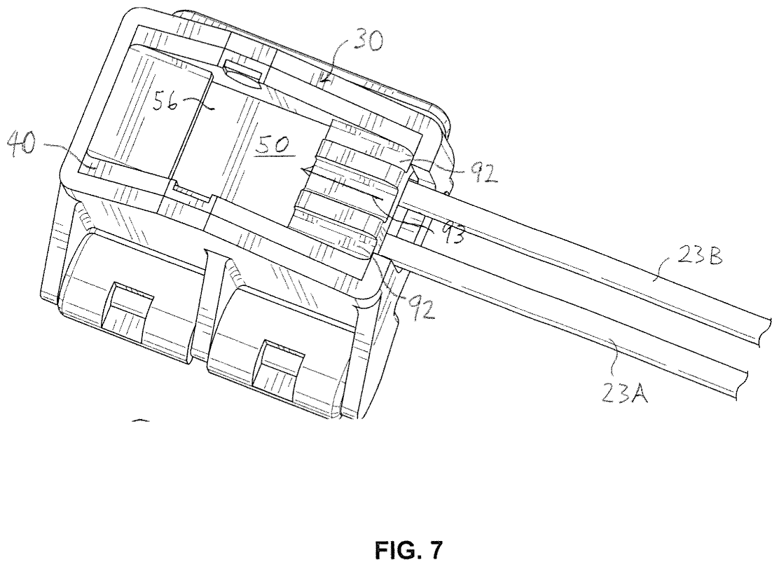

Preferably, the junction box 20 also includes the slider body 50. In one embodiment, the slider body 50 has respective channels 52A, 52B therein in which end segments 54A, 54B of the respective lead wires 22A, 22B are received. As will be described, the first ends 44A, 44B of the respective blade contacts 42A, 42B preferably are secured to the end segments 54A, 54B respectively. It is also preferred that the slider body 50 is slidably positioned inside the lock body 30 (FIG. 7).

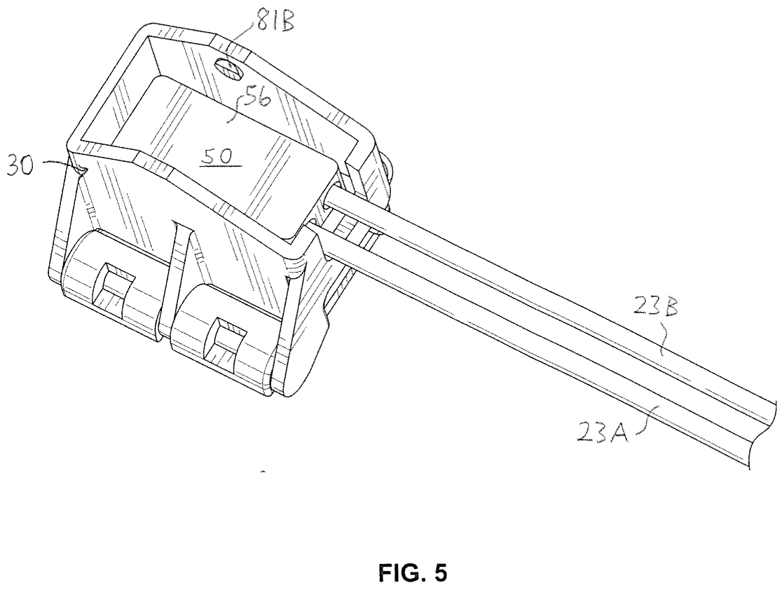

The channels 52A, 52B can be seen in FIG. 4, and the end segments 54A, 54B are shown in FIG. 1A. In FIG. 5, the slider body 50 is shown positioned in the lock body 30.

It will be understood that, in FIG. 5, the slider body 50 is shown after the contact elements 42A, 42B have been attached at their respective first ends 44A, 44B to the end segments 54A, 54B respectively. Preferably, the contact elements 42A, 42B are made of electrically conductive material, e.g., a suitable metal or metal alloy. Those skilled in the art would appreciate that the first ends 44A, 44B are electrically connected with the respective first and second lead wires 22A, 22B at the respective end segments 54A, 54B thereof, in any suitable manner. For example, parts of the insulation 23A, 23B on the lead wires 22A, 22B may be removed from the end segments 54A, 54B of the wires 22A, 22B, and the respective first ends 44A, 44B may then be crimped onto or otherwise secured onto the end segments 54A, 54B, for electrical connection therewith (FIG. 6).

For clarity of illustration, the slider body 50 is omitted from FIG. 6. The positions of the contact elements 42A, 42B inside the slider body and inside the lock body 30 in relation to the lead wires 22A, 22B and the floor element 38 can be seen in FIG. 6.

It will be understood that once the first ends 44A, 44B of the contact elements 42A, 42B are secured to the respective end segments 54A, 54B of the first and second lead wires 22A, 22B inside the slider body 50, the contact elements 42A, 42B are stationary (or substantially stationary) relative to the slider body 50. The second ends 46A, 46B of the contact elements 42A, 42B extend from the second side 55 of the slider body 50 (FIG. 4). Accordingly, movement of the slider body 50 relative to the lock body 30 causes corresponding movement of the second ends 46A, 46B of the blade contacts 42A, 42B relative to the lock body 30. The movement of the slider body 50 inside the lock body 30 (relative to the lock body 30), when the unlocked junction box is locked, will be described.

In order to assemble the junction box 20, the first ends 44A, 44B of the blade contacts 42A, 42B are first connected with the respective and segments 54A, 54B and positioned inside the slider body 50, as described above, to provide the subassembly illustrated in FIG. 4. Next, the slider body 50 preferably is positioned in the lock body 30, as shown in FIG. 5. As can be seen in FIG. 7, the slider case 40 preferably is then located on the slider body 50, inside the lock body 30.

It will be understood that the slider case 40 is omitted from FIG. 5 for clarity of illustration.

As can be seen in FIG. 7, when the slider body 50 is received inside the lock body 30, the first side 56 of the slider body 50 faces toward the lead side 34 of the lock body 30, i.e., toward the opening 32. When the slider body 50 is inside the lock body 30, the oppositely positioned second side 55 of the slider body 50 faces toward the main cable side 36 of the lock body 30, i.e., toward the floor element 38. Preferably, the second side 55 of the slider body 50 includes slots 60A, 60B through which the second ends 46A, 46B of the blade contacts 42A, 42B respectively extend (FIG. 4).

In one embodiment, the pinch lever 62 preferably includes a cam surface 64 thereon (FIG. 1C-1E). As will be described, the cam surface 64 is formed for engagement with the first side 56 of the slider body 50 (FIGS. 1C-1F). In one embodiment, the first side 56 preferably is generally planar. As noted above, the pinch lever 62 preferably is rotatable between the inactive position (FIGS. 1C, 1D, 2A, 2B, 8), in which the pinch lever 62 does not urge the slider body 50 toward the floor element 38 of the lock body 30, and a locked position (FIGS. 1F, 3A, 3B, 9), in which the cam surface 64 urges the slider body 50 against the floor element 38.

From the foregoing, it can be seen that when the pinch lever 62 is in the inactive position, the junction box 20 is in an unlocked condition. Also, when the pinch lever 62 is in the locked position, the junction box 20 is in a locked condition (FIG. 1B).

It will be understood that the lock body 30 and the slider case 40 are omitted from FIGS. 1C, 1D, and 1F for clarity of illustration.

As can be seen in FIGS. 2B and 2B, movement of the pinch lever 62 from its inactive position to its locked position preferably causes corresponding movement of the slider body 50 toward the floor element 38. The slider body 50 preferably is movable relative to the lock body 30 by the pinch lever 62 from a disengaged position of the slider body (FIG. 2B), in which the second side 55 is spaced apart from an internal side 65 of the floor element 38 to define the cavity “C” therebetween, to an engaged position thereof (FIG. 3B), in which the pinch lever 62 holds the second side 55 of the slider body 50 against the internal side 65 of the floor element 38. When the pinch lever 62 is moved from its inactive position to its locked position, the slider body 50 is moved from its disengaged position (FIG. 2B) to its engaged position (FIG. 3B). As will be described, when the pinch lever 62 is in its inactive position, the junction box 20 is in its unlocked condition, and when the pinch lever 62 is in its locked position, the junction box 20 is in its locked condition.

As shown in FIGS. 2B and 3B, the floor element 38 also has an external side 66 opposite to the internal side 65. Floor element slots 67A, 67B in the floor element 38 (FIG. 6) preferably are respectively aligned with the slots 60A, 60B in the slider body 50, when the slider body 50 is received in the lock body 30. The contact elements 42A, 42B preferably extend through the slots 60A, 60B and also are extendable through the slots 67A, 67B (when the pinch lever moves from its inactive position to its locked position) so that the second ends 46A, 46B extend through the slots 67A, 67B past the external side 66 of the floor element 38 (FIGS. 4-9).

As can be seen in FIGS. 2B and 3B, movement of the slider body 50 from its disengaged position to its engaged position (indicated in FIGS. 2B and 3B by arrow “A”) causes corresponding movement in the same direction of the second ends 46A, 46B of the respective blade contacts 42A, 42B.

In one embodiment, the junction box 20 preferably also includes the clamp device 70 mounted to the main cable side 36 of the lock body 30, for holding a locked segment “L” of the main cable 24 in a predetermined position relative to the second ends 46A, 46B of the contact elements 42A, 42B (FIGS. 2B, 3B).

Upon rotation of the pinch lever 62 from its inactive position (FIG. 2B) to the locked position thereof, the pinch lever 62 pushes the slider body 50 to the engaged position thereof (FIG. 3B). When the slider body 50 moves to the engaged position, the second ends 46A, 46B of the contact elements 42A, 42B are driven into the respective main cable wires 28A, 28B, for electrically connecting the load wires 22A, 22B and the main cable wires 28A, 28B respectively via the first and second contact elements 42A, 42B, and the junction box 20 is in the locked condition thereof.

In one embodiment, the junction box 20 preferably also includes the slider case 40 that is receivable in the opening 32 (i.e., in the receptacle 39) in the lock body 30 (FIGS. 1A, 7). As can be seen, for instance, in FIGS. 1A, 2B, and 3B, the slider body 50 is slidably receivable in the slider case 40. Those skilled in the art would appreciate that utilizing the slider case 40, which is formed to guide the slider body 50 when the slider body 50 moves, but without impeding such movement, may simplify manufacturing of the junction box 20, and thereby decrease manufacturing costs.

As will be described, the pinch lever 62 preferably is mounted to the lock body 30 and to the slider case 40 for rotation about an axis 82 of the pinch lever 62 (FIG. 1D). The direction in which the pinch lever 62 is rotated, to move the pinch lever 62 from its inactive position to its locked position, is indicated by arrow “G” in FIG. 2B.

For clarity of illustration, the points 48A at the second end 46A are shown in FIG. 3B as engaging the main cable wire 28A. It will be understood that, at the same time, the points 48B at the second end 46B engage the main cable wire 28B (not shown in FIG. 3B).

It will also be understood that the main cable 24 is omitted from FIGS. 2A, 2B, and 3A for clarity of illustration.

Preferably, the junction box 20 also includes the gel 68 that is positioned in the cavity “C” when the slider body 50 is in the disengaged position (FIG. 2B). Those skilled in the art would appreciate that the gel 68 is schematically represented in FIG. 2B, for clarity of illustration. It will also be understood that the gel 68 is at least partially squeezed out of the cavity “C” when the slider body 50 is moved to the engaged position thereof (FIG. 3B).

From the foregoing, it will be understood that, when the gel 68 is at least partially squeezed out of the cavity “C”, some of the gel 68 is directed through the slots 60A, 60B, to at least partially cover the portions of the contact elements 42A, 42B extending through the slots 60A, 60B, and in particular to at least partially cover the end segments 54A, 54B and the first ends 44A, 44B. At the same time, some of the gel 68 is directed through the floor element slots 67A, 67B, to at least partially cover portions of the contact elements 42A, 42B extending through the floor element slots 67A, 67B, and also in particular to at least partially cover the second ends 46A, 46B and the main cable wires 28A, 28B at the locations where the points 48A, 48B puncture the insulation 26 and engage the main cable wires 28A, 28B (FIG. 3B).

The clamp device 70 may be any suitable device that secures the locked segment “L” of the main cable 24 to the main cable side 36 of the lock body 30. As can be seen in FIG. 10A, in one embodiment, the clamp device 70 preferably includes a door 72 pivotably mounted to the lock body 30, and pivotable between an open position (FIG. 10A), in which the locked segment “L” of the main cable 24 may be positioned against the main cable side 36 of the lock body 30, and a closed position (FIGS. 10E, 10F), in which the door 72 partially defines a compartment 74.

As can be seen in FIGS. 2B, 3B, and 10E, the compartment 74 is also partially defined by the external side 66 of the floor element 38.

As shown in FIGS. 2A and 6, the lock body 30 preferably includes hinge elements 76 on one side of the lock body 30 to which the door 72 is pivotably mounted, for rotation of the door 72 about a hinge axis “X” (FIG. 6) between the door's open and closed positions. The lock body 30 preferably also includes one or more latch elements 77 on the other side thereof (FIG. 10A). In use, the door 72 is pivoted about the axis “X” (as indicated by arrow “H” in FIG. 10B) and cooperates with the latch elements 77 to hold the door 72 in its closed position, as shown in FIGS. 10C and 10D. As can be seen in FIGS. 10A and 10B, in one embodiment, the door 72 preferably includes openings 73 in which the latch elements 77 are receivable in a snap fit.

When the door 72 is in its open position, the locked segment “L” of the main cable 24 preferably is positioned against the external side 76 of the floor element 38, as shown in FIG. 10B. The door 72 is then pivoted about the hinge axis “X” in the direction indicated by arrow “H” to the door's closed position, in which the latch elements 77 are secured in the openings 73, to hold the locked segment “L” of the main cable 24 in the compartment 74, as shown in FIG. 10C.

The compartment 74 is also shown in FIGS. 10E and 10F. It will be understood that the main cable 24 is omitted from FIGS. 10E and 10F for clarity of illustration.

Once the locked segment “L” of the main cable 24 is held in the compartment 74 by the door 72, the pinch lever 62 preferably is moved from its inactive position to its locked position. As shown in FIGS. 2B and 10C, when the locked segment “L” is first positioned in the compartment 74, the pinch lever 62 is in the inactive position thereof.

As can be seen in FIGS. 2B, 8, and 10E, when the pinch lever 62 is in its inactive position, the slider body 50 is in its disengaged position, and as a result, the points 48A, 48B generally do not extend (or extend only small distances) past the external side 66 of the floor element 38, into the compartment 74. However, when the pinch lever 62 is moved from its inactive position to its locked position (FIGS. 3B, 9, 10D, 10F), the slider body 50 is moved in the direction indicated by arrow “A” in FIG. 3B, to push the second ends 46A, 46B past the external side 66, so that the points 48A, 48B puncture the main cable insulation 26 to push into, and engage with, the main cable wires 28A, 28B. In this way, the contact elements 42A, 42B are electrically connected with the respective main cable wires 28A, 28B.

As described above, when the slider body 50 is moved from its disengaged position to its engaged position, the gel 68 is substantially squeezed from the cavity “C”, to travel through the slots 60A, 60B to or toward the first ends 44A, 44B and also to travel through the floor element slots 67A, 67B to or toward the second ends 46A, 46B and the points 48A, 48B. As will be described, the gel 68 is intended to provide some degree of electrical insulation at the connections of the contact elements 42A, 42B made with the lead wires at the first ends 44A, 44B, at the connections of the contact elements 42A, 42B made with the cable wires at the second ends 46A, 46B, and generally on the first and second contact elements 42A, 42B.

In FIG. 10E, it can be seen that, when the pinch lever 62 is in its inactive position (i.e., when the junction box 20 is in its unlocked condition), the second ends 46A, 46B are substantially located in the slots 67A, 67B in the floor element 38. However, as can be seen in FIG. 10F, when the pinch lever 62 is in its closed condition (i.e., when the junction box 20 is in its locked condition), the slider body 50 (not shown in FIG. 10F) is in its engaged position, and the second ends 46A, 46B of the blade contacts 42A, 42B and the points 48A, 48B thereof extend from the external side 66 of the floor element 38 into the compartment 74.

From the foregoing, it can be seen that, when the pinch lever 62 is moved from its inactive position (FIGS. 2A, 2B) to its locked position (FIGS. 3A, 3B), the second ends 46A, 46B of the contact elements 42A, 42B are driven into the main cable 24, to puncture the insulation 26, and to engage with the main cable wires 28A, 28B respectively, thereby electrically connecting the lead wires 22A, 22B with the main cable wires 28A, 28B respectively, via the respective first and second contact elements 42A, 42B. When the pinch lever 62 is in its locked position, the second ends 46A, 46B remain engaged with the respective main cable wires 28A, 28B, and the slider body 50 is held in its engaged position, engaged with the floor element 38.

As can be seen in FIGS. 1A, 2A, and 3A, the pinch lever 62 preferably includes two axle elements 78A, 78B that fit into apertures 80A, 80B therefor (FIG. 1A), to permit rotation of the pinch lever 62 about an axis 82 thereof (FIG. 1D). As can be seen in FIG. 1A, the slider case 40 preferably includes the apertures 80A, 80B. It is also preferred that the lock body 30 includes additional apertures 81A, 81B that are aligned with the apertures 80A, 80B, when the slider case 40 is positioned in the lock body 30 (FIGS. 1A, 5). When the pinch lever 62 rotates from its inactive position to its locked position, the cam surface 64 engages the first side 56 of the slider body 50, to push the slider body 50 in the direction indicated by arrow “A” in FIGS. 2B and 3B.

As can be seen in FIG. 1E, the pinch lever 62 preferably includes a pinch lever body 84 with a main portion 86 and a handle portion 88. The cam surface 64 is on the main portion 86. Preferably, the cam surface 64 includes a rounded corner part 89, a flat part 90, and cam parts 91 (FIG. 1E). When the pinch lever 62 begins to rotate from its open condition to its closed condition, the rounded corner portion 89 initially engages the first side 56 of the slider body 50, urging the slider body 50 toward its engaged position (FIGS. 1C, 1D). Continuing rotation of the pinch lever 62 to its locked position locates the flat portion 90 flush against the first side 56. It will be understood that, when the flat portion of the pinch lever 62 is mated with and flush against the first side 56 of the slider body 50, the pinch lever 62 and the slider body 50 are locked together, forming an over center lock.

As can be seen in FIG. 1A, the slider case 40 includes one or more engagement surfaces 92 that are formed to be at an angle, inclined toward the first surface 56 of the slider body 50 when the junction box is assembled, in the direction generally indicated by arrow 93 (FIG. 7). As the pinch lever 62 is rotated to its locked position, past the point at which the rounded corner part 89 engages the first side 56, the cam parts 91 of the cam surface 64 slidably engage the engagement surfaces 92 of the slider case 40, which guide the main portion 86 toward the first side 56. At that point, the engagement surfaces 92 urge the pinch lever 62 against the first surface 56, and continue to do so when the flat part 90 is engaged with the first surface 56. The direction in which the engagement surfaces 92 urge the pinch lever 62 in response to the pressure of the cam parts 91 is generally indicated by arrow “J” in FIG. 1F.

From the foregoing, it can be seen that the pinch lever 62 and the first side 56 of the slider body 50 cooperate to provide an over center lock, locking the junction box 20 in the locked condition thereof, when the pinch lever 62 is in its locked position. When the pinch lever 62 is in its locked position, as shown in FIGS. 1F and 3B, the pinch lever 62 is held in that position because of the engagement of the cam parts 91 with the engagement surfaces 92. Those skilled in the art would appreciate that, when the junction box is in the locked condition, the risk of inadvertent disconnection of the lead wires from the main cable wires is minimized.

As noted above, the junction box 20 is intended to be installed outside, e.g., as part of a landscape lighting system (not shown). Those skilled in the art would appreciate that the junction box 20 may be only partially assembled, before it is brought to the site where the junction box 20 is to be installed.

In use, when the junction box 20 is delivered to the site, a user (not shown) preferably secures the first ends 44A, 44B of the contact elements 42A, 42B to the respective end segments 54A, 54B of the lead wires 22A, 22B (FIG. 6), from which insulation 23A, 23B has been removed. The respective first ends 44A, 44B and the end segments 54A, 54B respectively secured thereto are located in the slider body 50 (FIGS. 4, 5).

The gel 68 is positioned generally on the internal side 65 of the floor element 38. Once this is done, the slider body 50 (with the lead wires attached to the first ends 44A, 44B of the contact elements 42A, 42B inside the slider body 50) is positioned in the lock body 30, as can be seen in FIGS. 1A and 5. The slider case 40 is then positioned inside the lock body 30, on the slider body 50 (FIG. 7).

At this point, the slider body 50 is in its disengaged position, defining the cavity “C” between the second side 55 of the slider body 50 and the internal side 65 of the floor element 38, in which the gel 68 is located (FIG. 2B). The pinch lever 62 is then mounted to the lock body 30 and the slider case 40, i.e., the axle elements 78A, 78B are positioned in the respective apertures 80A, 80B. The pinch lever 62 is then in its inactive position, the slider body 50 is in its disengaged position, and the junction box 20 is in its unlocked condition (FIGS. 2B, 8, 10A-10C, 10E).

From the foregoing, it will be understood that the pinch lever 62 is not moved to its locked position (i.e., to put the junction box 20 into its locked condition) until the junction box 20 is located at its ultimate installation location, and the locked segment “L” of the main cable 24 is located in the compartment 74.

As described above, the end segments 54A, 54B of the lead wires 22A, 22B preferably are connected to the first ends 44A, 44B of the contact elements 42A, 42B inside the slider body 50, so that electrical current may be conducted between the contact elements 42A, 42B and the respective lead wires 22A, 22B. Also, the gel 68 is positioned on the internal side 65 of the floor element 38. Once this step has been completed, the slider body 50 (with the contact elements connected with the respective end segments 54A, 54B inside the slider body 50, as is shown in FIGS. 5 and 6), may be positioned in the receptacle 39 in the lock body 30 (FIG. 1A). As can be seen in FIG. 4, the second ends 46A, 46B of each of the two blade contacts 42A, 42B project through the slots 60A, 60B in the second side 55 of the slider body 50. When the slider body 50 is positioned in the lock body 30 (FIG. 5), the second ends 46A, 46B preferably are at least partially positioned in the respective floor element slots 67A, 67B in the floor element 38 (FIG. 6).

The slider body 50 is formed to fit inside the lock body 30 and be movable relative to the lock body 30, and the slider case 40 is receivable in the lock body 30, partially engaged with the first side 56 of the slider body 50. As noted above, before the slider body 50 is positioned inside the lock body 30, the gel 68 preferably is positioned on the internal side 65 of the floor element 38.

The slider case 40 fits on top of the slider body 50, as can be seen in FIG. 7. The slider case 40 rests on the floor element 38 of the lock body 30 (FIG. 2B). The slider case 40 allows the slider body 50 to be moved relative to the slider case 40 and relative to the lock body 30 in the direction indicated by arrow “A”, when the pinch lever 62 is moved from its inactive position to its locked position.

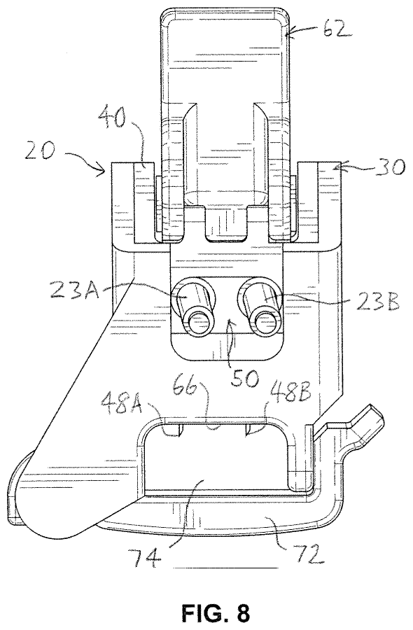

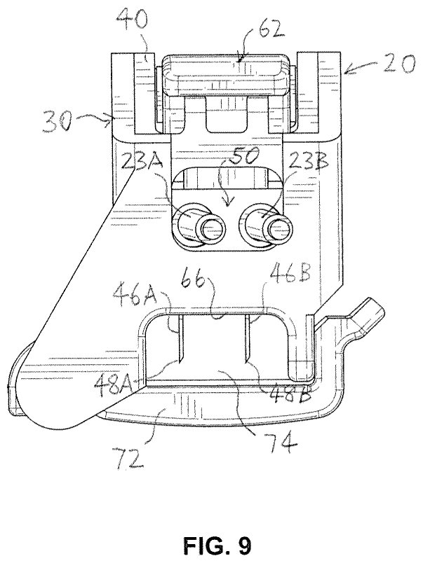

In FIG. 8, the pinch lever 62 is in the inactive position there, but in FIG. 9, the pinch lever 62 has been moved to the locked position thereof. As presented in FIG. 8, the slider body 50, and the lead wires 22A, 22B extending therefrom, are positioned higher, relative to the slider case 40 and the lock body 30, than is shown in FIG. 9.

When the pinch lever 62 is moved from its inactive position to its locked position, the cam surface 64 on the pincher lever 62 engages the first side 56 of the slider body 50. The cam surface 64 is rounded, so that as the pincher lever 62 completes its rotation to its locked position, the pincher lever 62 simultaneously urges the slider body 50 in the direction indicated by arrow “A” in FIGS. 2B and 3B until the second side 55 of the slider body 50 engages the internal side 65 of the floor element 38. When the second side 55 engages the internal side 65 of the floor element 38, the pinch lever 62 is in its locked position, in which it cooperates with the slider body 50 to form an over center lock.

As noted above, the movement of the slider body 50 in the direction indicated by arrow “A” substantially eliminates the cavity “C”, to squeeze the gel 68 both (i) through the slots 60A, 60B in the second side 55 of the slider body 50 to cover the first ends 44A, 44B of the contact elements 42A, 42B and the end segments 54A, 54B engaged therewith, and (ii) through the floor element slots 67A, 67B to cover the second ends 46A, 46B of the contact elements 42A, 42B and the main cable wires 28A, 28B engaged therewith at points 48A, 48B. The gel 68 also at least partially covers the portions of the contact elements 42A, 42B that extend through the slots 60A, 60B and through the floor element slots 67A, 67B.

The gel 68 may be any suitable silicone-based or other material that may be squeezed into position and then remains in position over an extended period of time, remaining flexibly adhered to the blade contacts and wires over a wide temperature range. The gel is intended to protect against water and corrosion. The gel may be provided in the cavity “C” in any suitable manner. For example, the gel 68 may be provided in a package positioned on the internal side 65 that releases the gel when squeezed, or the gel 68 may simply be manually spread on the internal side 65 of the floor element 38 of the lock body and/or on the second side 55 of the slider body 50 when the junction box is assembled. Those skilled in the art would be aware of suitable gels.

The gel 68 is intended to insulate the electrically conductive elements in the junction box 20 from water, and to protect against corrosion. As described above, the gel 68 is intended to at least partially cover the end segments 54A, 54B and the first ends 44A, 44B of the contact elements 42A, 42B, and second ends 46A, 46B and the main cable wires 28A, 28B, and the gel 68 preferably also at least partially covers the contact elements 42A, 42B along their respective lengths, between the first ends and second ends of each. Also, because the first ends 44A, 44B of the contact elements 42A, 42B are inside the slider body 50, the first ends 44A, 44B are protected by the slider body 50 from direct exposure to water.

It will be understood that the main cable 24 is omitted from FIGS. 10E and 10F for clarity of illustration. In FIGS. 10E and 10F, the compartment 74 is shown, first, when the junction box 20 is in its unlocked condition (FIG. 10E), and second, when the junction box 20 is in its locked condition (FIG. 10F), in which the second ends 46A, 46B of the blade contacts 42A, 42B are shown extend relatively far from the external side 66 of the floor element 38 into the compartment 74.

As can be seen in FIG. 10G, an assembly 94 of the invention preferably includes the junction box 20 and an indicator subassembly 96 that is electrically connected with the lead wires 22A, 22B. It will be understood that the lead wires 22A, 22B (not shown in FIG. 10G) are inside an output cable 25. It will also be understood that the main cable, which includes main cable wires 28A, 28B that are electrically connected with the lead wires 22A, 22B respectively, is omitted from FIG. 10G for clarity of illustration.

Preferably, the indicator subassembly 96 is connected with a proximal portion 97 of the output cable 25 that extends from the junction box 20. As can be seen in FIG. 10G, the indicator subassembly 96 preferably includes an indicator body 98 extending between first and second ends 101, 103 thereof. As illustrated in FIG. 10G, the indicator body 98 preferably is formed at the first end 101 to mate with an end (not shown) of a distal portion of the output cable 25 that is connected to an electricity-consuming device that is part of a landscape lighting system, e.g., a light fixture. Those skilled in the art would appreciate that any suitable means for electrically connecting the proximal and distal portions of the output cable may be used.

Preferably, the indicator subassembly 96 includes an indicator element 105 (i.e., a light-emitting diode (LED)) that is energized when current is passed along the output cable 25. It will be understood that, in FIG. 10H, a circuit 107 that includes the LED 105 preferably is connected with the lead wires 22A, 22B (not shown in FIG. 10H) inside the output cable 25 at “K” and “M”. The indicator element 105 is configured to provide one or more confirmation signals to indicate that the lead wires are energized, upon energization of the first and second lead wires.

From the foregoing, it can be seen that the indicator subassembly 96 may be used to provide the user with confirmation that the lead wires 22A, 22B are electrically connected with the main cable wires 28A, 28B promptly, after the lead wires 22A, 22B and the main cable wires 28A, 28B are electrically connected inside the junction box 20. In practice, this is useful, and can save the user time, because the user can quickly determine whether the electrical connections between the lead wires 22A, 22B and the main cable wires 28A, 28B have been effected. If the LED 105 is not energized after the portions of the main cable have been connected together and the main cable has been energized, the user knows immediately that the desired connections have not been achieved. On the other hand, if the LED 105 is energized when the connected portions of the main cable are energized, this provides confirmation to the user that the desired connections have been made.

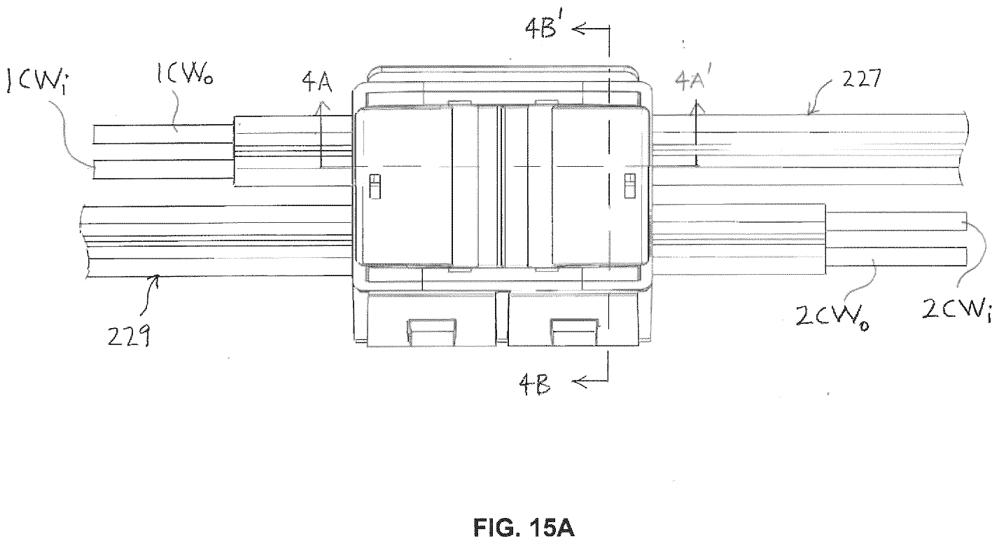

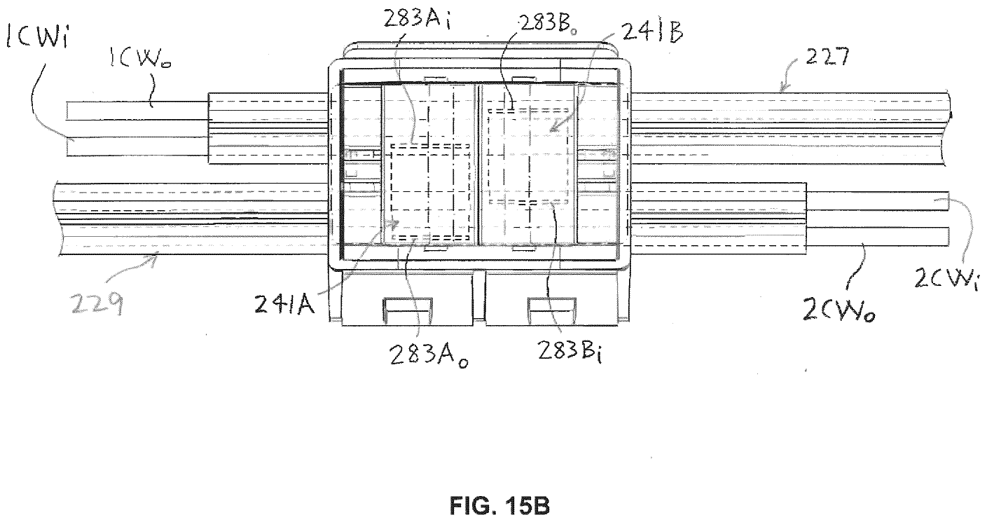

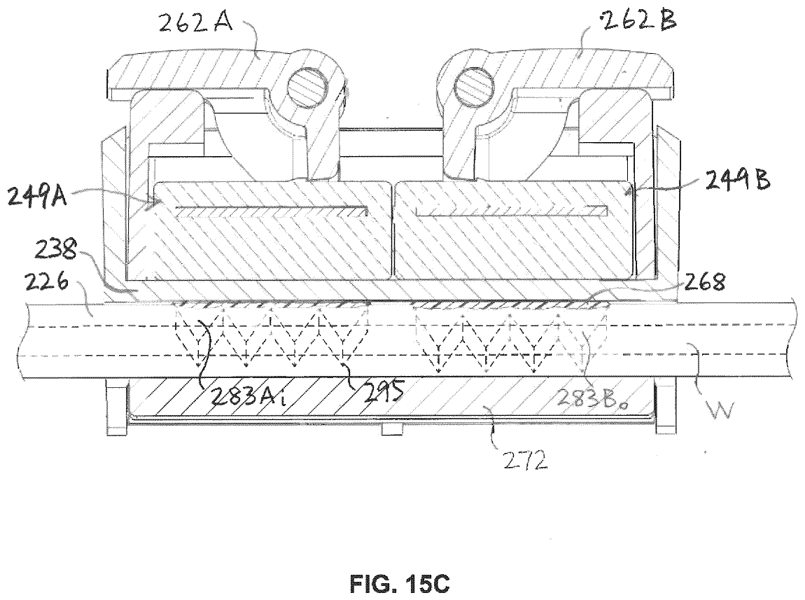

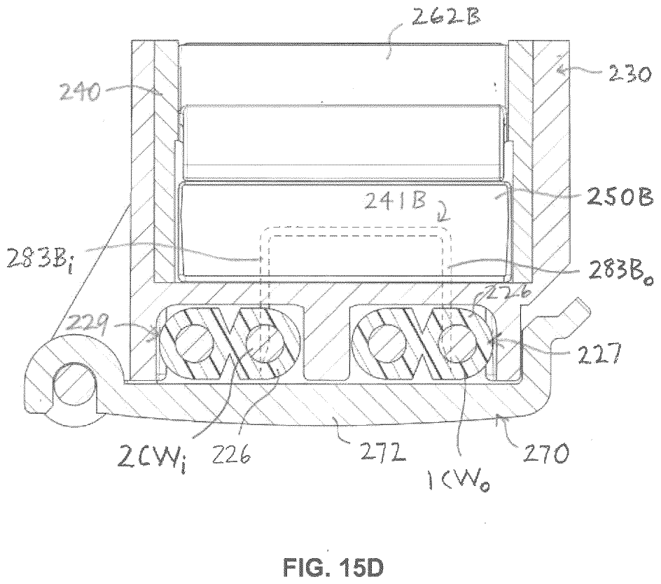

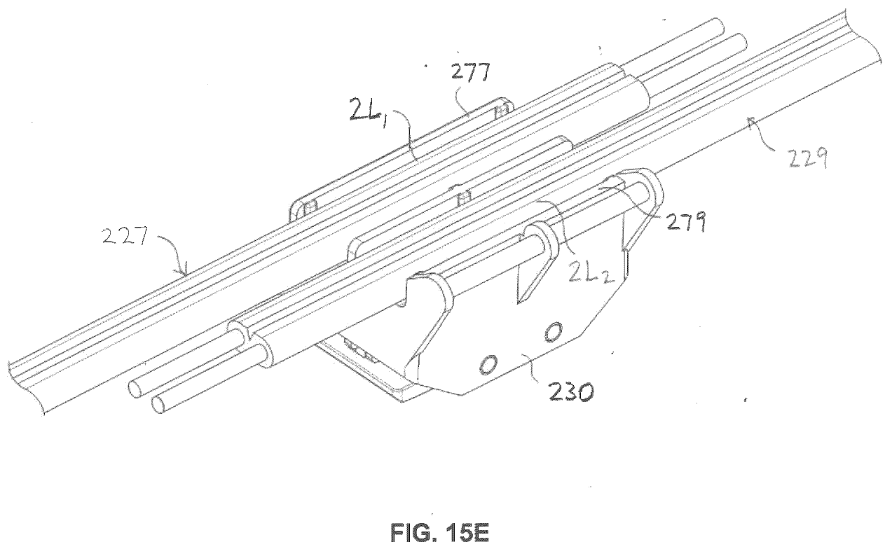

Another embodiment of the system 220 or junction box of the invention is illustrated in FIGS. 11A-15E. As will be described, the junction box 220 is for electrically connecting conductors that are inner and outer first cable wires 1CWᵢ, 1CWₒ in a first main cable 227 with respective outer and inner second cable wires 2CWₒ, 2CWᵢ in a second main cable 229 (FIGS. 11B, 15B). It will be understood that the junction box 220 may be utilized as an alternative to manually splicing the first and second main cables together in the field. The main cables 227, 229 are omitted from certain of the drawings for clarity of illustration.

As an example, the inner and outer first cable wires 1CWᵢ, 1CWₒ may be connected with an electrical load (e.g., a junction box, at which lead wires are connected with the first cable wires), and the inner and outer second cable wires 2CWᵢ, 2CWₒ may be connected with a source (not shown) of electrical energy.

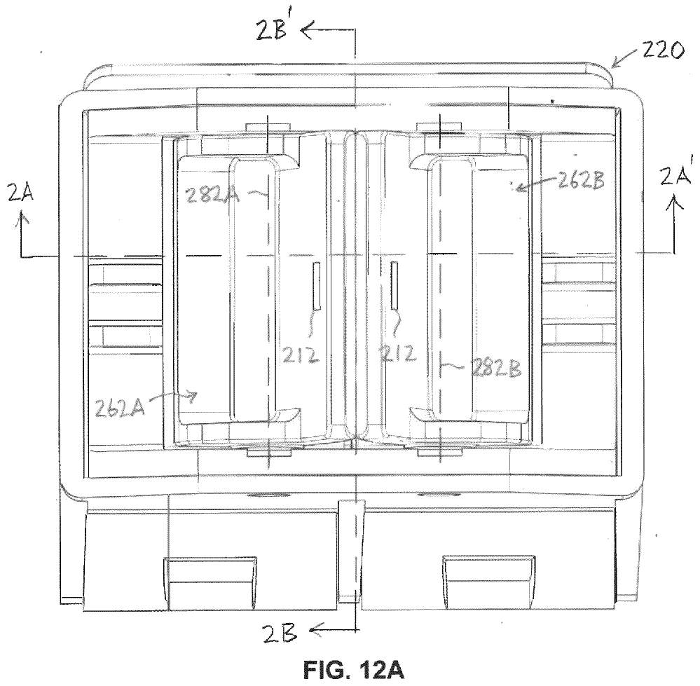

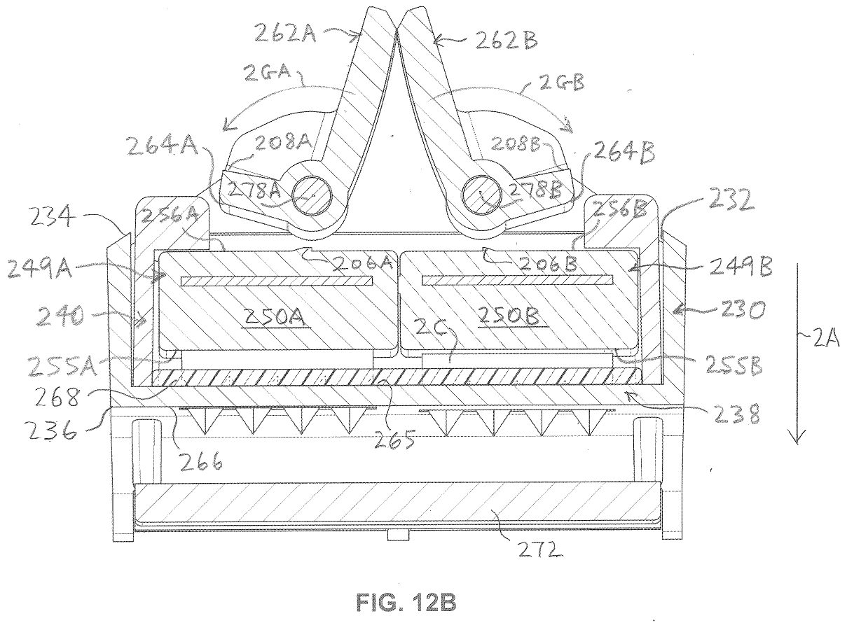

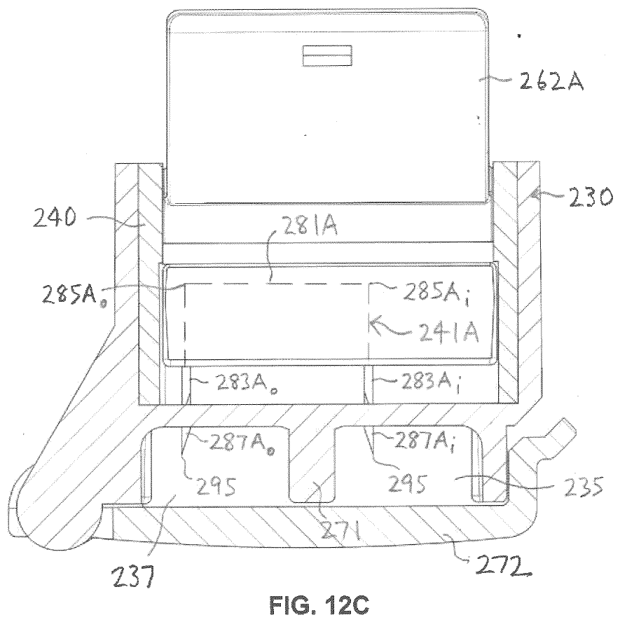

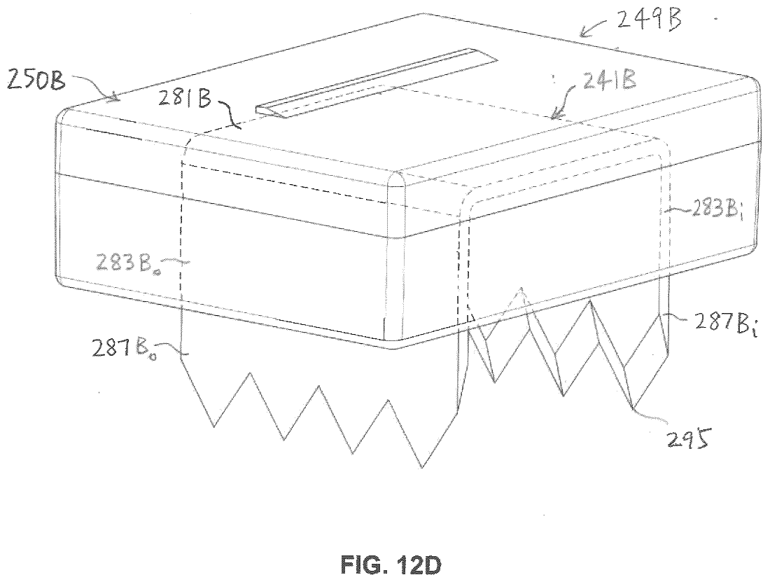

In one embodiment, the junction box 220 preferably includes a lock body 230 defining an opening 232 therein. The lock body 230 preferably includes a wall 231 extending between a first side 234 and a second side 236 thereof. The lock body 230 preferably includes a floor element 238 located between the first and second sides 234, 236 (FIG. 12B). The wall 231 and the floor element 238 define a receptacle 239 in the lock body 230.

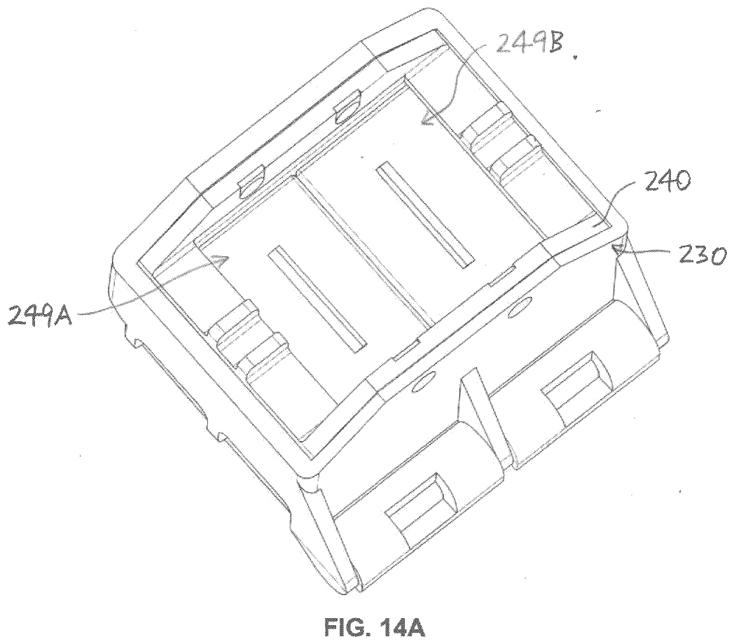

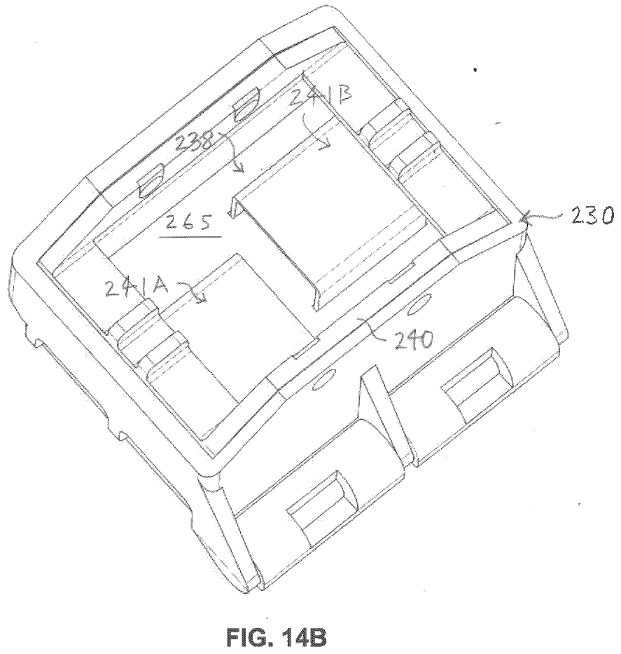

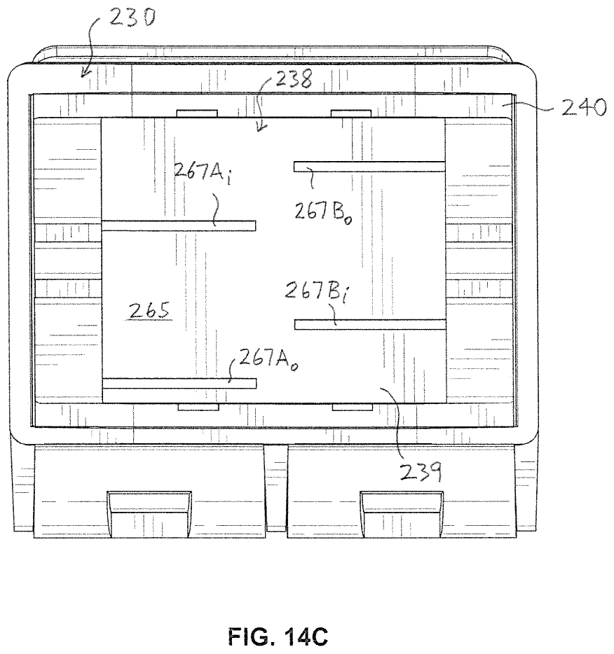

The junction box 220 preferably also includes first and second contact elements 241A, 241B (FIG. 14B). Preferably, the first and second contact elements 241A, 241B are made of electrically conductive material, e.g., a suitable metal or metal alloy. As will be described, the first contact element 241A preferably is formed for electrically connecting the inner first cable wire 1CWᵢ of the first main cable 223A and the outer second cable wire 2CWₒ of the second main cable 229. The second contact element 241B preferably is formed for electrically connecting the outer first cable wire 1CWₒ of the first main cable 227 and the inner second main cable wire 2CWᵢ of the second main cable 229.

In one embodiment, the junction box 220 preferably includes one or more slider subassemblies. Each of the slider subassemblies preferably includes a slider body in or on which the first and second contact elements 241A, 241B are respectively secured. In the example illustrated, the junction box 220 preferably includes two slider subassemblies. For clarity of illustration, the two slider subassemblies are identified by reference characters 249A, 249B, and the two slider bodies thereof are identified by reference characters 250A, 250B, as can be seen in FIGS. 12B, 13C, and 15C. Preferably, the slider subassemblies 249A, 249B are positioned inside the lock body 230.

As noted above, the contact elements 241A, 241B preferably are secured in or on the respective slider bodies 250A, 250B. The contact element 241B, illustrated in FIG. 12D, includes a body portion 281B and preferably also includes blade contacts 283Bᵢ, 283Bₒ that extend from the body portion 281B. As can be seen in FIG. 12D, it is preferred that the blade contacts extend orthogonally from the body portion.

It will be understood that the contact element 241A is the same as the contact element 241B in all relevant respects. For clarity of illustration, only the contact element 241B is shown in FIG. 12D. The contact element 241A is also illustrated, for example, in FIG. 12C.

The contact elements 241A, 241B may be secured in or on the slider bodies 250A, 250B in any suitable manner. In one embodiment, for example, the slider bodies 250A, 250B are formed by injection molding, and the contact elements 241A, 241B preferably are positioned with the body portions 281A, 281B embedded in the slider bodies 250A, 250B so that the blade contacts 283Aᵢ, 283Aₒ and 283Bᵢ, 283Bₒ extend from the floor sides 255A, 255B of the respective slider bodies 250A, 250B.

The slider bodies 250A, 250B preferably each include lever sides 256A, 256B thereof facing toward the opening 232 of the lock body 230 and away from the floor element 238, and oppositely-positioned floor sides 255A, 255B facing toward the floor element 238, when the slider subassemblies 249A, 249B are positioned in the slider case 240 (FIG. 12B).

As can be seen in FIG. 12D, the blade contacts preferably extend between inner ends thereof, at which they are secured to the body portion therefor, and outer ends thereof. Preferably, the outer ends include a number of sharp points. As will be described, the sharpened points are formed to cut through the insulation 226 that covers the main cable wires 227, 229 when the pinch levers are moved to their respective closed positions, so that the blade contacts will engage the main cable wires, to form electrical connections.

For example, in FIG. 12D, the blade contacts 283Bᵢ, 283Bₒ are connected with the body portion 281B at their respective inner ends 285Bᵢ, 285Bₒ . . . The blade contacts 283Bᵢ, 283Bₒ extend between the inner ends 285Bᵢ, 285Bₒ and outer ends 287Bᵢ, 287Bₒ thereof. The outer ends 287Bᵢ, 287Bₒ preferably include a number of sharp points 295. The outer ends 287Bᵢ, 287Bₒ extend from the slider body 250B, beyond the floor side 255B (FIG. 12D).

As can be seen in FIGS. 12C, 13D, and 14B, the contact element 241A preferably includes a body portion 281A to which blade contacts 283Aᵢ, 283Aₒ, are secured. Preferably, the blade contacts 283Aᵢ, 283Aₒ extend between respective inner ends 285Aᵢ, 285Aₒ, and outer ends 287Aᵢ, 287Aₒ. The outer ends 287Aᵢ, 287Aₒ preferably include a number of sharp points 295. The outer ends 287Aᵢ, 287Aₒ extend from the slider body 250A, beyond the floor side 255A (FIG. 12C).

Preferably, the junction box 220 also includes one or more pinch levers with cam surfaces thereon, for engagement with the lever sides 256A, 256B of the slider bodies 250A, 250B. In the example illustrated, there are two pinch levers, identified by reference characters 262A, 262B, as can be seen, e.g., in FIGS. 11A, 12B, 13A, and 15A.

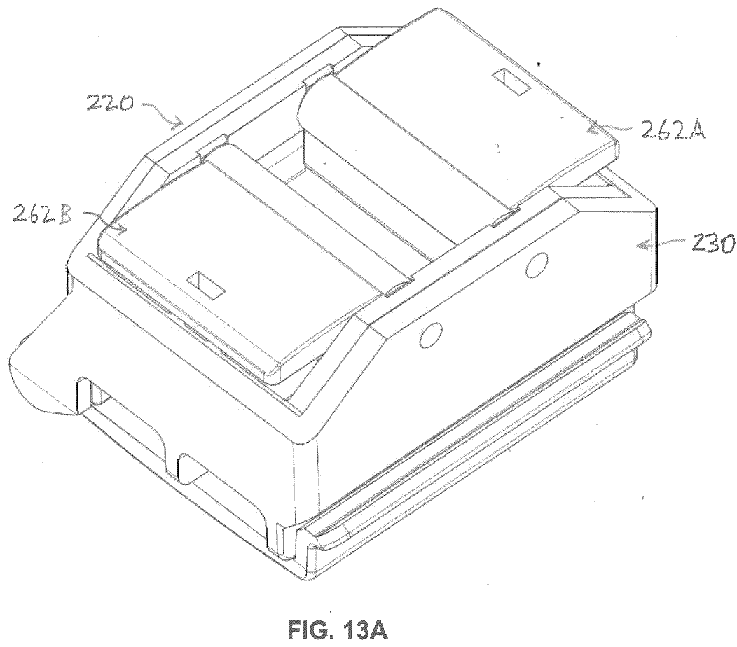

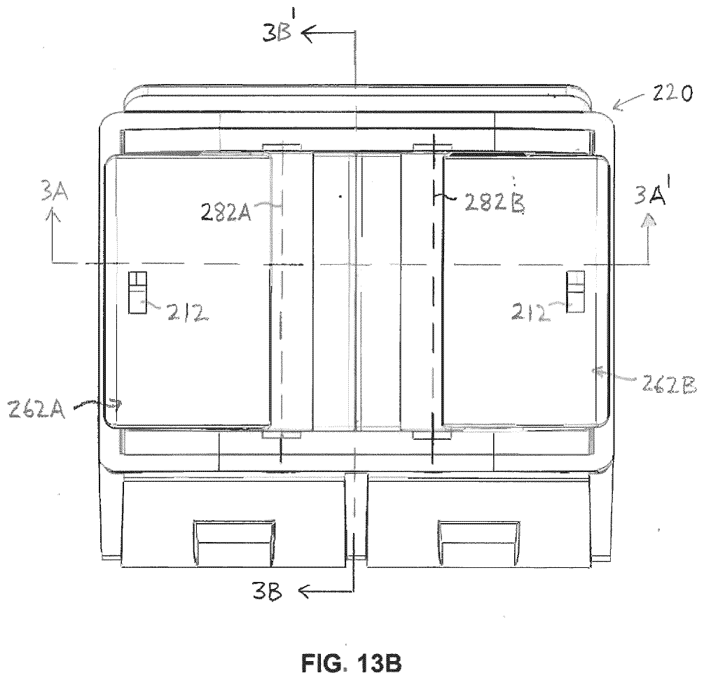

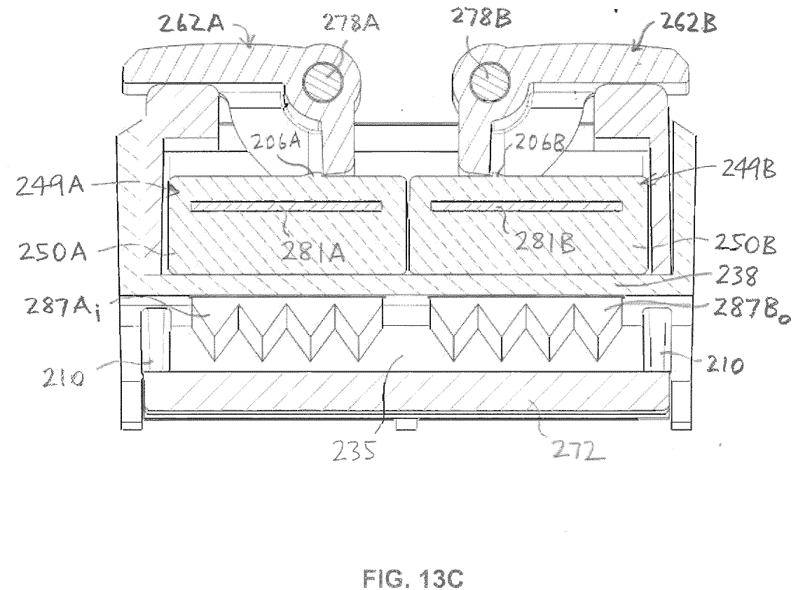

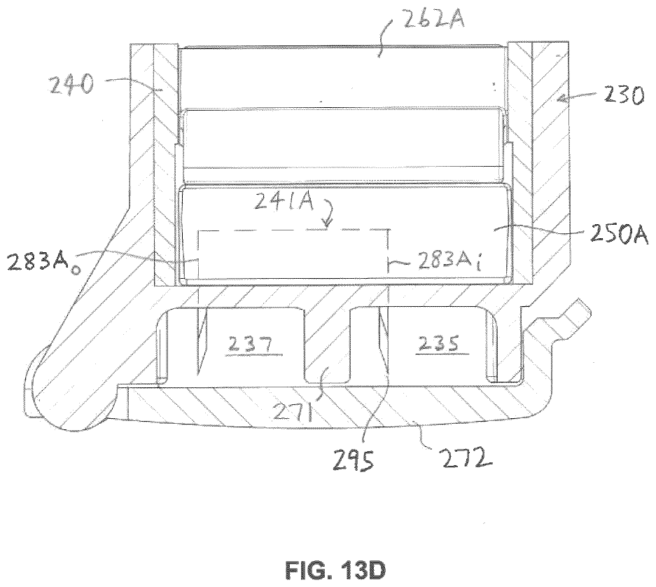

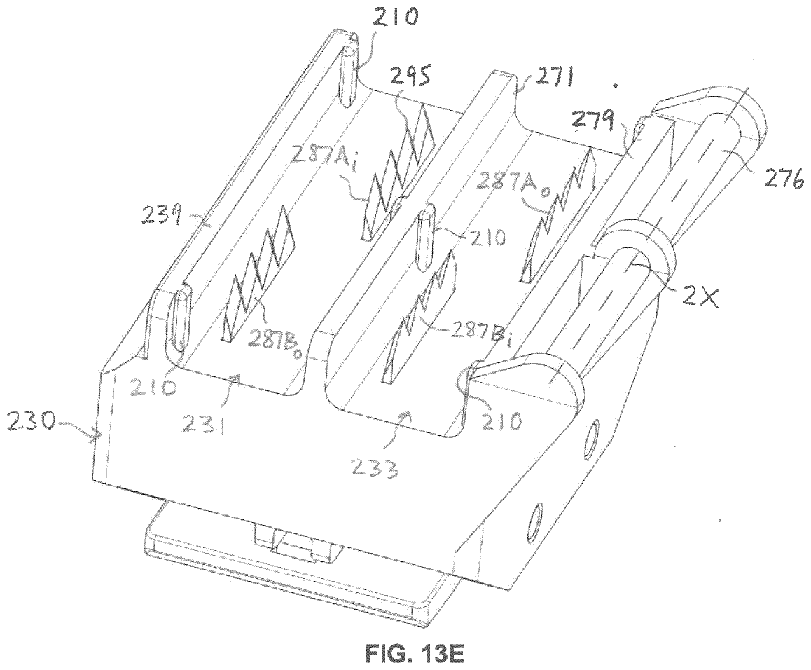

The pinch levers 262A, 262B have respective cam surfaces 264A, 264B thereon (FIG. 12B). The pinch levers 262A, 262B are each movable from an inactive position thereof, in which the pinch levers 262A, 262B do not urge the slider bodies 250A, 250B to move toward the floor element 238, and a locked position thereof, in which the pinch levers 262A, 262B locate the respective slider bodies 250A, 250B proximate to the floor element 238. The pinch levers 262A, 262B are shown in their respective inactive positions in FIG. 12B, and they are shown in their respective locked positions in FIGS. 13C and 15C.

As will be described, the lever sides 256A, 256B of the slider bodies 250A, 250B preferably are formed for engagement by the respective cam surfaces 264A, 264B.

The slider bodies 250A, 250B preferably are each movable by the pinch levers 262A, 262B relative to the lock body 230 from respective disengaged positions thereof (when the pinch levers 262A, 262B are in their respective inactive positions) (FIG. 12B) to respective engaged positions thereof (when the pinch levers 262A, 262B are in their respective locked positions) (FIGS. 13C, 15C). When the slider bodies 250A, 250B are in the disengaged positions thereof, the floor sides 255A, 255B of the slider bodies 250A, 250B thereof are both spaced apart from the floor element 238, to define a cavity “2C” therebetween (FIG. 12B). It can be seen in FIG. 12B that when the slider bodies 250A, 250B are in their respective disengaged positions, they are positioned distal to the floor element 238. When the slider bodies 250A, 250B are in the engaged positions thereof, the slider bodies 250A, 250B are proximal to the floor element 238 (FIGS. 13C, 15C).

Preferably, when the slider bodies 250A, 250B are in their respective engaged positions, they are engaged with the floor element 238. Specifically, in their respective engaged positions, the floor sides 255A, 255B thereof are engaged with the floor element 238.

It is also preferred that the junction box 220 includes a clamp device 270 that is mounted to the lock body 230, for holding respective locked segments “2L₁”, “2L₂” of the first and second main cables 227, 229 in respective predetermined positions relative to the first and second contact elements 241A, 241B. As will be described, the locked segments “2L₁”, “2L₂” of the main cables 227, 229 are held in their respective predetermined positions to align the main cable wires therein with the blade contacts of the contact elements.

When the pinch levers 262A, 262B are moved from their respective inactive positions to their respective locked positions, the pinch levers 262A, 262B push the respective slider bodies 250A, 250B from the respective disengaged positions thereof to the respective engaged positions thereof, in which the floor sides 255A, 255B of the slider bodies 250A, 250B are urged against the floor element 238. The direction of movement of the slider bodies 250A, 250B from their disengaged positions to their engaged positions is indicated by arrow “2A” in FIG. 12B. As will be described, due to such movement, the first contact element 241A is driven into the inner first cable wire 1CWᵢ of the first main cable 227 and the outer second cable wire 2CWₒ of the second main cable 229, and the second contact element 241B is driven into the outer first cable wire 1CWₒ of the first main cable 227 and the inner second cable wire 2CWᵢ of the second main cable 229.

It is also preferred that the junction box 220 includes a slider case 240 receivable in the opening 232 in the lock body 230 (FIG. 12B). The slider subassemblies 249A, 249B preferably are slidably receivable in the slider case (240).

In one embodiment, the junction box 220 preferably also includes a gel 268 that is positioned in the cavity “2C”, when the slider subassemblies 249A, 249B are in the disengaged positions thereof (FIG. 12B). The gel 268 is at least partially squeezed out of the cavity when the slider bodies 250A, 250B are moved to the engaged positions thereof, due to movement of the pinch levers 262A, 262B from their respective inactive positions to their respective locked positions (FIGS. 13C, 15C).

The pinch levers 262A, 262B preferably are mounted to the lock body 230 and to the slider case 240 for rotation about respective axes 282A, 282B (FIGS. 12A, 13B). The axes 282A, 282B are defined by respective axle elements 278A, 278B (FIG. 12B). The directions in which the pinch levers 262A, 262B are rotated, to move the pinch levers 262A, 262B from their open conditions to their closed conditions, are indicated by arrows “2GA”, “2GB” in FIG. 12B.

It will be understood that the pinch levers 262A, 262B and the respective lever sides 256A, 256B of the slider bodies 250A, 250B cooperate to provide respective over center locks, when the pinch levers 262A, 262B are in their respective locked positions. When the pinch levers 262A, 262B are in their respective inactive positions, the junction box 220 is in an unlocked condition. When the pinch levers 262A, 262B are in their respective locked positions, the junction box 220 is in a locked condition thereof. Those skilled in the art would appreciate that the risk of inadvertent disconnection of the contact elements from the main cable wires is thereby minimized, when the pinch levers 262A, 262B are in their respective locked positions.

As can be seen in FIG. 12B, in one embodiment, the slider bodies 250A, 250B preferably include respective stop elements 206A, 206B that are located on the lever sides 256A, 256B thereof. When the pinch levers 262A, 262B are pivoted in the directions indicated by arrows “2GA”, “2GB”, the pinch levers 262A, 262B preferably are pivoted about their respective axes 282A, 282B until respective mating surfaces 208A, 208B on the pinch levers 262A, 262B have been moved past the stop elements 206A, 206B, as shown in FIG. 13C. As can be seen in FIGS. 12B and 13C, the stop elements 206A, 206B are formed to allow the cam surfaces 264A, 264B to move over the stop elements when the pinch levers are pivoted in the directions indicated by arrows “2GA”, “2GB”. Once the pinch levers have pivoted past the stop elements, the stop elements 206A, 206B engage the mating surfaces 208A, 208B, to resist movement of the pinch levers 262A, 262B in directions opposite to the directions indicated by arrows “2GA”, “2GB”.

From the foregoing, it can be seen that once the pinch levers 262A, 262B have been moved to their respective locked positions, the pinch levers 262A, 262B are secured therein, and inadvertent disconnection is unlikely.

The floor element 238 preferably includes an internal side 265, formed to face toward the respective floor sides 255A, 255B of the slider bodies 250A, 250B (FIG. 12B). The floor element 238 preferably also includes an external side 266, positioned oppositely to the internal side 265. As can be seen in FIGS. 12B and 13C, the floor sides 255A, 255B preferably are substantially flat. When the slider bodies 250A, 250B are in their engaged positions, the floor sides 255A, 255B preferably mate with the internal side 265 of the floor element 238 (FIGS. 13C, 15C).

The floor element 238 preferably includes slots 267Aᵢ, 267Aₒ and 267Bᵢ, 267Bₒ, as will be described (FIG. 14C). It will be understood that each of the floor element slots extends through the floor element 238, i.e., between the internal side 265 and the external side 266.

The floor element slots are sufficiently large to permit unimpeded movement of the blade contacts in the floor element slots, when the slider subassemblies 249A, 249B are moved from the disengaged positions thereof to the engaged positions thereof.

It is also preferred that the floor element 238 includes a central wall 271 that extends from the external side 266. As can be seen in FIGS. 11C, 11D, 11E, 12C, 13D, and 13E, the central wall 271 preferably extends outwardly, i.e., away from the internal side 265, to at least partially define troughs 231, 233. Preferably, the lock body 230 includes outer walls 239, 279 that also partially define the troughs 231, 233 respectively (FIGS. 11C, 11D, 13E).

Preferably, the contact elements 241A, 241B are positioned in the respective slider bodies 250A, 250B so that, when the slider bodies 250A, 250B are in their disengaged positions, the blade contacts of the respective contact elements 241A, 241B partially fit into the floor element slots. Specifically, the blade contacts 283Aᵢ, 283Aₒ partially fit into the floor element slots 267Aᵢ, 267Aₒ, and the blade contacts 283Bᵢ, 283Bₒ partially fit into the floor element slots 267Bᵢ, 267Bₒ.

As can be seen in FIGS. 11C and 11D, when the slider subassemblies 249A, 249B are in their disengaged positions, the outer ends 287Aᵢ, 287Aₒ, 287Bᵢ, 287Bₒ of the respective blade contacts 283Aᵢ, 283Aₒ, 283Bᵢ, and 283Bₒ extend a relatively small distance through the floor element slots from the external side 266 of the floor element 238. It can also be seen in FIGS. 11C and 11D that the blade contacts 283Aᵢ, 283Aₒ extend through the floor element slots 267Aᵢ, 267Aₒ respectively, and the blade contacts 283Bᵢ, 283Bₒ extend through the floor element slots 267Bᵢ, 267Bₒ respectively, when the slider subassemblies 249A, 249B are in their disengaged positions.

As noted above, when the slider bodies 250A, 250B are moved from their disengaged positions to their engaged positions, the blade contacts are pushed further through the floor element slots, so that the outer ends 287Aᵢ, 287Aₒ, 287Bᵢ, 287Bₒ of the blade contacts are pushed further past the external side 266 of the floor element 238.

The extent to which the blade contacts extend from the external side 266 of the floor element 238 can be seen in FIG. 13E. It will be understood that, in FIG. 13E, the pinch levers 262A, 262B are in their closed positions, and the slider subassemblies 249A, 249B are in their engagement positions. As can be seen in FIG. 13E, in these circumstances, the outer ends 287Aᵢ, 287Aₒ, 287Bᵢ, and 287Bₒ extend relatively far outwardly, from the external side 266 of the floor element 238.

It will also be understood that the main cables 227, 229 and the lock door 272 are omitted from FIG. 13E for clarity of illustration.

As can be seen in FIG. 15E, the respective locked segments “2L₁”, 2L₂″ of the main cables 227, 229 preferably are receivable in the respective troughs 231, 233. Once the locked segments “2L₁”, “2L₂” are positioned in the troughs 231, 233, the clamp device 270 preferably is moved to its engaged position (FIG. 15D), to hold the locked segments “2L₁”, “2L₂” in the respective troughs 231, 233. It will be understood that, at this point, the slider bodies 250A, 250B are in their disengaged positions. Subsequently, the slider bodies 250A, 250B are moved from the disengaged positions thereof to the engaged positions thereof, to cause the blade contacts to be pushed into the main cables, for contact with the main cable wires as described above.

As can be seen in FIGS. 11C, 11D, and 11E, the troughs 231, 233 are defined by the external side 266 of the floor element 238, the central wall 271, and the outer walls 277, 279. A first side 202A of the central wall 271 partially defines the trough 231, and a second side 202B of the central wall 271 partially defines the trough 233 (FIGS. 11C, 11D).

Those skilled in the art would appreciate that, as a practical matter, keeping the locked segments in the predetermined positions thereof may be difficult, both before the blade contacts are inserted into the main cables, and also while the blade contacts are inserted into the main cables. Accordingly, in one embodiment, the walls that partially define the troughs 231, 233 preferably have projections extending therefrom into the troughs 231, 233, for securing the main cables in the troughs 231, 233.

The projections are identified by reference character 210, and can be seen in FIGS. 11C, 11D, and 13E. The projections 210 serve to narrow the troughs 231, 233 in selected regions thereof, so as to hold the locked segments “2L₁”, “2L₂” of the main cables 227, 229 in the predetermined positions thereof, due to friction. In the examples illustrated in those views, the projections preferably are not positioned opposite to each other, e.g., projections on the outer walls 277, 279 are positioned at the ends of the troughs 231, 233, and projections on the central wall 271 are located generally midway between the ends of the troughs 231, 233. Those skilled in the art would appreciate that any suitable arrangement may be made to hold the locked segments “2L₁”, “2L₂” in the predetermined positions thereof.

The clamp device 270 may be any suitable device for securing the locked segments “2L₁”, “2L₂” of the main cables 227, 229 in the respective troughs 231, 233. As can be seen in FIGS. 11C and 11E, in one embodiment, the clamp device 270 preferably includes a door 272 pivotably mounted to the lock body 230 and pivotable between an open position (FIG. 11C), in which the locked segments “2L₁”, “2L₂” of the main cables 227, 229 may be positioned in the respective troughs 231, 233, and a closed position (FIGS. 11E, 15D). As can be seen in FIGS. 11E, 12C, 13D, and 15D, when the door 272 is in its closed position, the door 272 partially covers the troughs 231, 233 to define compartments 235, 237 (FIGS. 11E, 12C, 13D).

As will be described, the locked segments “2L₁”, 2L₂” are first secured in the compartments 235, 237 before the slider subassemblies 249A, 249B are moved to their engaged positions.

As can also be seen in FIGS. 11C and 11D, the lock body 230 preferably includes hinge elements 276 on one side of the lock body 230 to which the door 272 is pivotably engaged, for rotation of the door 272 about a hinge axis “2X” (FIG. 11D) between the door's open and closed positions. The lock body 230 preferably also includes one or more latch elements 277 on the other side thereof (FIG. 11D). In use, the door 272 is pivoted about the axis “2X” (as indicated by arrow “2H” in FIG. 11C) and cooperates with the latch elements 277 to hold the door 272 in its closed position, as shown in FIGS. 11E and 15D.

In use, the assembled junction box 220 in its unlocked condition is transported to the site at which the main cables 227, 229 are to be electrically connected. As can be seen in FIGS. 11A and 12A, in one embodiment, the pinch levers 262A, 262B preferably include holes 212 through which a suitable tie element (not shown) may be drawn, to connect the open pinch levers 262A, 262B together when they are in their respective inactive positions, so that the risk of unintentionally moving the pinch levers to the locked positions thereof prior to installation is minimized. At the site, the junction box 220 preferably is positioned with the pinch levers 262A, 262B in their open positions and the slider bodies 250A, 250B in their respective disengaged positions, and with the clamp device 270 unlocked, i.e., with the door 272 in its open position (FIG. 11C). Next, the locked segments “2L₁”, “2L₂” of the main cables 227, 229 are positioned in the troughs 231, 233 respectively, as illustrated, e.g., in FIG. 15E. Preferably, the main cables 227, 229 are held in the troughs 231, 233 by the projections 210.

The door 272 is then moved to its closed position, and locked into place by engagement of the door with the latch elements 277.

Next, the pinch levers 262A, 262B are moved from their open positions to their locked positions, causing the slider bodies 250A, 250B to move from their respective disengaged positions to their respective engaged positions.

As noted above, when the slider bodies 250A, 250B move from their disengaged positions to their engaged positions, the blade contacts 283Aᵢ, 283Aₒ, 283Bᵢ, and 283Bₒ are pushed further into the floor element slots, pushing the points 295 at the outer ends of the blade contacts through the insulation 226 on the main cables 227, 229 so that the outer ends 287Aᵢ, 287Aₒ, 287Bᵢ, 287Bₒ push into the main cable wires.

In FIG. 15B, it can be seen that, when the slider bodies 250A, 250B are in their engaged positions, the first contact element 241A electrically connects the main cable wires 1CWᵢ and 2CWₒ and the second contact element 241B electrically connects the main cable wires 1CWₒ and 2CWᵢ. Specifically, the blade contacts 283Aₒ and 283Aᵢ electrically connect the main cable wires 2CWₒ and 1CWᵢ respectively, and the blade contacts 283Bᵢ, 283Bᵢ electrically connect the main cable wires 1CWₒ and 2CWᵢ respectively.

As noted above, in one embodiment, the junction box 220 may include the gel 268 positioned in the cavity, when the slider bodies 250A, 250B are in their respective disengaged positions. The gel 268 may be positioned, for example, on the internal side 265 of the floor element 238 (FIG. 12B). Those skilled in the art would appreciate that the gel 268 may be positioned on the internal side 265 when the junction box 220 is assembled, i.e., before the junction box 220 is brought to the installation site therefor.

When the slider bodies 250A, 250B are moved from their disengaged positions to their engaged positions, the floor sides 255A, 255B of the respective slider bodies 250A, 250B preferably are urged against the internal side 265 of the floor element 238, thereby substantially eliminating the cavity “2C”, causing displacement of the gel 268. Due to the positions of the floor element slots relative to the floor sides 255A, 255B, when the slider subassemblies 249A, 249B are moved to their engaged positions, much of the gel 268 is pushed into the floor element slots by the floor sides 255A, 255B.

It will be understood that the gel 268 is omitted from FIG. 13C for clarity of illustration.

From the foregoing description, it can be seen that, at the same time (or substantially at the same time) as the gel 268 is pushed down the floor element slots, the blade contacts slice into the insulation 226, and into the respective main cable wires. As an example, the positions of the blade contacts 283Aᵢ, 283Bₒ after the blade contacts have cut into the insulation 226 and engaged the main cable wires are shown in FIG. 15C. For convenience, the main cable wires that are engaged by the blade contacts 283Aᵢ, 283Bₒ are identified collectively by the reference character “W” in FIG. 15C. It will be understood that, when the blade contacts cut into the insulation and move further into the main cables until they engage the main cable wires, much of the gel 268 that may have been positioned on the blade contacts is wiped off, primarily as the outer ends of the blade contacts pass through the insulation. This situation is schematically illustrated in FIG. 15C.

It will be understood that the blade contacts 283Aₒ, 283Bᵢ are not shown in FIGS. 12B, 13C, and 15C for clarity of illustration. The positions of the blade contacts 283Aₒ, 283Bᵢ when the slider subassemblies 249A, 249B are in their disengaged and engaged positions correspond to the positions of the blade contacts 283Aᵢ, 283Bₒ in all relevant respects. The positions of the blade contacts 283Aᵢ, 283Aₒ when the slider subassembly 249A is in its engaged position are shown in FIG. 13D, and the positions of the blade contacts 283Bᵢ, 283Bₒ when the slider subassembly 249B is in its engaged position are shown in FIG. 15D.

The gel 268 is intended to insulate the electrically conductive elements in the junction box 220 and in the main cables from water, and to protect against corrosion. The gel 268 may be any suitable silicone-based or other material that may be squeezed into position and then remains in position over an extended period of time, remaining flexibly adhered to the blade contacts and the main cables over a wide temperature range. The gel is intended to protect against water and corrosion. The gel may be provided in any suitable manner. For example, the gel 268 may be provided in a package positioned in the cavity (e.g., on the internal side 265) that releases the gel when squeezed, or the gel 268 may simply be manually spread on the internal side 265 of the floor element 238 of the lock body when the junction box is assembled. Those skilled in the art would be aware of suitable gels.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A system for electrically connecting first and second load wires and first and second source wires respectively, the system comprising:
a lock body comprising at least one wall extending between a first side and a second side thereof, the lock body comprising a floor element secured to said at least one wall and located between the first and second sides, the lock body defining a receptacle therein between the first side and the floor element;
at least one contact element pair comprising a first contact element and a second contact element, for electrically connecting, via the first contact element, the first load wire and the first source wire, and for electrically connecting, via the second contact element, the second load wire and the second source wire, the first contact element extending between a first load end thereof, at which the first contact element is formed for electrical connection with the first load wire, and a first source end thereof, at which the first contact element is formed for electrical connection with the first source wire, and the second contact element extending between a second load end thereof, at which the second contact element is formed for electrical connection with the second load wire, and a second source end thereof, at which the second contact element is formed for electrical connection with the second source wire;
at least one slider body receivable in the receptacle and configured for movement therein relative to the lock body, said at least one contact element pair being at least partially mounted in said at least one slider body, for movement of said at least one contact element pair with said at least one slider body relative to the look body; and
at least one pinch lever movably mounted to the lock body, said at least one pinch lever being movable to a locked position thereof, wherein said at least one pinch lever locates said at least one slider body proximate to the floor element, from an inactive position of said at least one pinch lever, in which said at least one slider body is located distal to the floor element,
wherein said at least one slider body is located spaced apart from the floor element to define a cavity therebetween when said at least one pinch lever is in the inactive position thereof,
wherein, upon said at least one pinch lever moving from the inactive position to the locked position thereof, said at least one slider body is urged thereby toward the floor element, and the first contact element and the second contact element engage the first and second source wires respectively to electrically connect the first load wire with the first source wire, and to electrically connect the second load wire with the second source wire.

2. The system according to claim 1 in which, when said at least pinch lever is in the locked position, the slider body engages the floor element.

3. The system according to claim 2 in which said at least one pinch lever and said at least one slider body cooperate to form an over center lock when said at least one pinch lever is in the locked position thereof, securing said at least one slider body against the floor element.

4. The system according to claim 1 additionally comprising a slider case positioned in the receptacle of the lock body, said at least one slider body being receivable in the slider case and movable relative to the slider case.

5. The system according to claim 1 additionally comprising a gel positioned in the cavity when said at least one pinch lever is in the inactive position thereof, wherein the gel is at least partially squeezed out of the cavity by said at least one slider body when said at least one pinch lever is moved to the locked position thereof.

6. The system according to claim 1 additionally comprising a clamp device mounted to the second side of the lock body, for holding the first and second source wires stationary in relation to the lock body while said at least one pinch lever is moved from the inactive position to the locked position thereof.

7. A method of electrically connecting first and second load wires and first and second source wires respectively, the method comprising:
electrically connecting the first load wire with a first load end of a first contact element;
electrically connecting the second load wire with a second load end of a second contact element;
at least partially mounting the first contact element and the second contact element to at least one slider body;
providing a lock body comprising at least one wall extending between first and second sides thereof, the lock body comprising a floor element secured to said at least one wall located between the first and second sides, the lock body defining a receptacle between the first side and the floor element in which said at least one slider body is movable relative to the lock body;
providing at least one pinch lever movably mounted to the lock body for movement from an inactive position to a locked position thereof; and
moving said at least one pinch lever from the inactive position thereof toward the locked position thereof, to urge said at least one slider body toward the floor element, to engage first and second source ends of first and second contact elements with the first and second source wires respectively, to electrically connect the first load wire and the first source wire via the first contact element, and to electrically connect the second load wire and the second source wire via the second contact element.

8. A system for electrically connecting first and second lead wires with first and second main cable wires in a main cable, the system comprising:
a lock body comprising at least one wall extending between a lead side and a main cable side thereof, the lock body including a floor element therebetween, to partially define a receptacle in the lock body;
a first contact element and a second contact element, for electrically connecting, via the first contact element, the first lead wire and the first main cable wire, and for electrically connecting, via the second contact element, the second lead wire and the second main cable wire;
the first contact element extending between a first lead end thereof, at which the first contact element is formed for electrical connection with the first lead wire, and a first main cable end, at which the first contact element is formed for electrical connection with the first main cable wire;
the second contact element extending between a second lead end thereof, at which the second contact element is formed for electrical connection with the second lead wire, and a second main cable end, at which the second contact element is formed for electrical connection with the second main cable wire;
at least one slider body in which the first lead end and the second lead end of the first and second contact elements are at least partially located and in which respective end segments of the first and second lead wires are receivable, the end segments of the first and second lead wires being electrically connected with the first lead end and the second lead end respectively, said at least one slider body being slidably positioned in the receptacle, said at least one slider body having a first side facing toward the lead side of the lock body and an oppositely positioned second side facing toward the main cable side of the lock body; and
at least one pinch lever comprising a cam surface for engagement with the first side of said at least one slider body, the pinch lever being movable between an inactive position thereof, in which said at least one slider body is in a disengaged position spaced apart from the floor element, and a locked position, in which the cam surface engages the slider body to hold said at least one slider body against the floor element,
wherein, upon said at least one pinch lever moving from the inactive position thereof to the locked position thereof, said at least one pinch lever pushes said at least one slider body from the disengaged position thereof to the engaged position thereof, to drive the second ends of the respective contact elements into the respective main cable wires, for electrically connecting the first and second lead wires with the first and second main cable wires respectively, via the respective first and second contact elements.

9. The system according to claim 8 in which, when said at least one pinch lever is in the inactive position, said at least one slider body is located to position the second side thereof spaced apart from the floor element, to define a cavity therebetween.

10. The system according to claim 9 in which the floor element comprises first and second slots therein through which the first and second contact elements are respectively partially movable, when said at least one pinch lever moves from the inactive position thereof to the locked position thereof.

11. The system according to claim 10 additionally comprising a gel positioned in the cavity, wherein the gel is at least partially squeezed out of the cavity when said at least one pinch lever is moved to the locked position thereof.

12. The system according to claim 8 in which said at least one pinch lever and the first side of said at least one slider body cooperate to form an over center lock when said at least one pinch lever is in the locked position thereof.

13. The system according to claim 8 additionally comprising a clamp device, for holding a selected portion of the main cable stationary relative to the lock body while said at least one pinch lever is moved to the locked position thereof, to cause the first main cable end and the second main cable end to engage the first and second main cable wires respectively, for electrically connecting the first and second main cable ends with the first and second main cable wires respectively.

14. The system according to claim 8 additionally comprising:
an indicator subassembly that is electrically connected with the first and second lead wires, the indicator subassembly comprising at least one indicator element, said at least one indicator element being configured to provide at least one confirmation signal to indicate that the lead wires are energized, upon energization of the first and second lead wires.

15. A system for electrically connecting inner and outer first cable wires in a first main cable with outer and inner second cable wires in a second main cable respectively, the system comprising:
a lock body comprising at least one wall extending between a first side and a second side thereof, the lock body including a floor element therebetween, said at least one wall and the floor element defining a receptacle in the lock body;
first and second contact elements, the first contact element being formed for electrically connecting the inner first cable wire and the outer second cable wire, and the second contact element being formed for electrically connecting the outer first cable wire and the inner second cable wire;
at least one slider body to which the first and second contact elements are secured, said at least one slider body being slidably positioned in the receptacle, said at least one slider body having a lever side facing toward the first side of the lock body and an oppositely positioned floor side facing toward the floor element;
at least one pinch lever comprising a cam surface for engagement with the lever side of said at least one slider body, said at least one pinch lever being movable from an inactive position, in which said at least one slider body is located distal to the floor element, and a locked position, in which said at least one slider body is located proximate to the floor element,
wherein, upon movement of said at least one pinch lever from the inactive position to the locked position, said at least one pinch lever pushes said at least one slider body against the floor element, driving the first contact element into the inner first cable wire of the first main cable and the outer second cable wire of the second main cable, and driving the second contact element into the outer first cable wire of the first main cable and the inner second cable wire of the second main cable.

16. The system according to claim 15 in which said at least one slider body defines a cavity between the floor side thereof and the floor element when said at least one pinch lever is in the inactive position thereof.

17. The system according to claim 16 additionally comprising a gel positioned in the cavity, the gel being at least partially squeezed out of the cavity when said at least one pinch lever moves to the locked position thereof.

18. The system according to claim 17 in which the floor element comprises first and second slots therein through which the first and second contact elements are partially movable.

19. The system according to claim 15 additionally comprising a clamp device, for holding at least one selected portion of the first and second main cables stationary relative to the lock body while said at least one pinch lever is moved to the locked position, to cause the first contact element to engage the inner first cable wire and the outer second cable wire, and to cause the second contact element to engage the outer first cable wire and the inner second cable wire, for electrical connection thereof.
